(19) United States
(12) Patent Application Publication
(10) Pub. No.: US 2021/0246776 A1
(43) Pub. Date: Aug. 12, 2021

(54) SYSTEM AND METHOD FOR ESTIMATING DISTRIBUTED STATIC AND KINEMATIC FRICTION, TORQUE AND RPM ALONG A DRILLSTRING IN A WELLBORE

(71) Applicants: UTI LIMITED PARTNERSHIP, NW Calgary (CA); ASSOCIATION POUR LA RECHERCHE ET DÉVELOPPEMENT DES METHODES ET PROCESSUS INDUSTRIELS, Paris (FR); NORCE NORWEGIAN RESEARCH CENTRE AS, Bergen (NO)

(72) Inventors: Roman Jgorevich SHOR, NW Calgary (CA); Florent DI MEGLIO, Paris (FR); Ulf Jakob Flo AARSNES, Oslo (NO)

(73) Assignees: UTI LIMITED PARTNERSHIP, NW Calgary, AB (CA); ASSOCIATION POUR LA RECHERCHE ET DEVELOPPEMENT DES METHODES ET PROCESSUS INDUSTRIELS, Paris (FR); NORCE NORWEGIAN RESEARCH CENTRE AS, Bergen (NO)

(21) Appl. No.: 17/055,825

(22) PCT Filed: May 15, 2019
(86) PCT No.: PCT/CA2019/050655

§ 371 Date: Nov. 16, 2020

Related U.S. Application Data
(60) Provisional application No. 62/671,742, filed on May 15, 2018.

(51) Int. Cl. E21B 44/04; G01L 5/00

(52) U.S. Cl. CPC E21B 44/04; G01L 5/0061

(57) ABSTRACT

A system for controlling a drill string located in a borehole. The drill string has a top portion and a bottom hole assembly (BHA) coupled thereto. The system includes: a processor; sensors coupled to the top portion of the drill string and to the processor. The sensors configured to measure values of variables of the top portion of the drill string, to obtain top portion measured value. A non-transitory tangible computer readable medium having instructions recorded thereon are carried out by the processor to obtain a soft sensor to generate estimated values of variables of the BHA in accordance with the top portion measured values and in accordance with angular motion equations of the drill string. A drill string controller is configured to generate a control signal in accordance with the estimated values of variables of the BHA to control the top portion in accordance with the control signal.

### FIELD OF THE INVENTION

The present disclosure relates to borehole drilling. In particular, the present disclosure relates to a system and method for controlling a drill string in a borehole.

### BACKGROUND OF THE INVENTION

Exploration and production of oil and gas in the deep subsurface, where hydrocarbon reservoirs are found at depths between 2,000 and 30,000 feet, requires that a narrow borehole, between 4 and 24 inches in diameter, be drilled using a slender drill-string through a varied downhole environment and along an often snaking well path. Drill string vibrations, and their negative consequences on the Rate of Penetration (ROP) and equipment, are a well known phenomenon when drilling for hydrocarbons. In particular, the torsional oscillations known as stick slip are considered to be some of the most prevalent vibrations. These stick-slip oscillations are characterized by a series of stopping—“sticking”—and releasing—“slipping” events of the bit.

Off-bottom stick slip is a well known phenomenon from the field, and when mentioned in literature is hypothesized to be caused by a negative difference between static and dynamic along-string Coulomb-type friction. This is an important phenomena as it indicates that non-linear frictional forces along the drill-string (and not just the bit rock interaction), in deviated or horizontal wells, plays a significant role in the torsional oscillatory behavior of drill-strings. Hence, models which only incorporate the bit rock interaction as the cause of torsional stick slip fail to explain off-bottom stick slip vibrations, as observed in field data after connections and in back-reaming operations.

The distributed effects of the drill string becomes an increasingly prominent feature of torsional dynamics in long wells, and perhaps especially wellbores with high-inclination laterals. The nonlinear nature of the Coulomb friction can excite a wide range of frequencies where higher order modes become essential for representing the dynamics of the system, in particular for long wells. Hence, lumped approximations of the drill string easily fall short, and it is desirable to employ distributed model representations of the torsional dynamics.

Therefore, improvements in the art of drilling for hydrocarbons are desirable.

### SUMMARY OF THE INVENTION

The present discloses an apparatus and method that provides insight to a drill operator with respect to the downhole behavior of a drill-string. The insight provided to the drill operator allows the operator to adjust the surface parameters of the drill-string in order to maximize ROP and/or other parameter of the drill-string. The surface parameters that can be adjusted by the drill operator include the angular velocity of the drill-string, the torque applied by the motor rotating the drill-string, and the weight applied to the bit attached at the distal end of the drill-string. The insight provided by the present disclosure can be in the form of displayed parameters such as, for example, the static coefficient of the drill-string, the dynamic coefficient of friction of the drill-string, the drill-string twist, the release torque, the sensor gains, the angular displacement of the drill-string, etc.

The estimates produced by the algorithm can be displayed to a driller in real time in an advisory system, and the result can be built on to help optimize the drilling operation, detect faults and unwanted incidents, aid on-site decision making, and improve control of directional drilling.

In a first aspect, the present disclosure provides a system for controlling a drill string located in a borehole, the drill string having a top portion and a bottom hole assembly (BHA) coupled to the top portion. The system comprises: a processor; sensors coupled to the top portion of the drill string, the sensors being further coupled to the processor, the sensors configured to measure values of variables of the top portion of the drill string, to obtain top portion measured values; a non-transitory, tangible computer readable medium having instructions recorded thereon, the instructions to be carried out by the processor to obtain a soft sensor to generate estimated values of variables of the BHA in accordance with the top portion measured values and in accordance with angular motion equations of the drill string; and a drill string controller configured to generate a control signal in accordance with the estimated values of variables of the BHA, the drill string controller to control the top portion in accordance with the control signal.

Other aspects and features of the present disclosure will become apparent to those ordinarily skilled in the art upon review of the following description of specific embodiments in conjunction with the accompanying figures.

### BRIEF DESCRIPTION OF THE FIGURES

FIG. 1 shows an elevation view of a drill string and of variables of the drill string encompassed in a torsional dynamics model of the drill string in accordance with the present disclosure.

FIG. 2 shows a model of a drill string element of the drill string of FIG. 1.

FIG. 3 shows pipe and a collar of the drill string of FIG. 1 and variables used in modeling the pipe and the collar.

FIGS. 4A, 4B and 4C respectively show modeled angular velocity, modeled applied torque, and the drill string configuration to which the modeled angular velocity and modeled applied torque correspond.

FIGS. 5A, 5B and 5C respectively show modeled angular velocity, modeled applied torque, and the drill string configuration to which the modeled angular velocity and modeled applied torque correspond.

FIG. 6 shows an example of data flow in accordance with an embodiment of the present disclosure.

FIG. 7 shows a flowchart of a method in accordance with an embodiment of the present disclosure.

FIG. 8 shows an example of a wellbore survey in accordance with the present disclosure.

FIGS. 9A-9C show, in relation to the wellbore survey of FIG. 8, example plots of measured and estimated top drive (top portion of the drill string) angular velocity as well as measured and estimated angular velocity of the BHA of the drill string, for three different different measurement frequencies of top drive variables.

FIGS. 10A-10C show plots of estimations of static and dynamic friction parameters as a function of time, for the plots shown in FIGS. 9A-9C respectively.

FIGS. 11A-11C show, in relation to an example of field data, plots of measured and estimated top drive (top portion of the drill string) angular velocity as well as measured and estimated angular velocity of the BHA of the drill string, for three different different measurement frequencies of top drive variables.

FIGS. 12A-12C show plots of estimations of static and dynamic friction parameters as a function of time, for the plots shown in FIGS. 10A-10C respectively.

FIG. 13 shows a box diagram of a drill sting controller in accordance with an embodiment of the present disclosure.

FIG. 14 shows plots of a mollifier and of the mollifier's derivatives in accordance with an embodiment of the present disclosure.

FIG. 15 shows plots of feed-forward terms in accordance with an embodiment of the present disclosure.

FIGS. 16A-16C show plots of angular velocity simulation results in accordance with an embodiment of the present disclosure.

FIGS. 17A-17E show plots of angular velocity simulation results in accordance with an embodiment of the present disclosure.

FIG. 18 shows a timing diagram in accordance with an embodiment of the present disclosure.

FIGS. 19A and 19B show plots of torque trends in accordance with embodiments of the present disclosure.

FIG. 20 shows plots of Riemann invariants in accordance with the present disclosure.

FIG. 21 shows contours corresponding to a required total transition time for a given magnitude and timing pair |\hat{d}|, tᵣ, in accordance with an embodiment of the present disclosure.

FIGS. 22A and 22B respectively show a Bode magnitude plot and a Bode phase plot in accordance with an embodiment of the present disclosure.

FIG. 23 shows a block diagram of a system in accordance with the present disclosure.

### DETAILED DESCRIPTION

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

A ‘soft-sensor’ as described herein, combines measurements from physical sensors with a model of system dynamics to provide estimates of various variables and parameters describing the state of the system. Without limitation, the variables may include, the rotational velocity of each section of the drill string and bottom hole assembly (BHA), the angular displacement at each section of the drill string and BHA, and the static and dynamic friction coefficients. The soft-sensor may comprise an observer algorithm. Observers include dynamical systems whose states are the estimates of the aforementioned variables. State dynamics may include a combination of: (i) ‘open-loop’ terms based on the equations of physics describing the behavior of the system; and/or (ii) ‘closed-loop’ terms that correct the dynamics based on the value of the measurements.

Disclosed herein is a soft-sensor system and method for drilling, comprising sensors for measuring operational parameters of a drill string, including detecting torque and angular velocity from a top drive, and incorporating a distributed model of the drill string with the Coulomb friction given as a source term implemented as an inclusion, where the states are propagated according to the Filipov solution [63]. The distributed nature of the model enables it to capture a large part of the possible dynamics for a significantly extended range of well lengths and surveys compared to the more standard lumped approximations. At the same time, the relative mathematical simplicity of the formulation, a one-dimensional (1-D) wave equation with a source term with ordinary differential equations (ODEs) as boundary conditions, enables the use of results from control theory to effectively derive a soft sensor as a Luenberger Observer. This soft sensor can in turn estimate dynamic and static friction factors as well as the distributed states of the system including drill string orientation and angular strain.

In accordance with the present disclosure, a soft sensor may utilize a distributed parameter model, i.e., a model described by a Partial Differential Equation (PDE) of a drill-string, with Coulomb stiction modeled as an inclusion, to estimate static and dynamic friction along the drill string and the angular displacement of the various drill string components. This method may initialize with the well plan (the wellbore survey) and the drill string configuration and then utilize real time sensed RPM and Torque from the top drive as inputs to an observer to provide an estimate of downhole behavior. The observer design may incorporate a backstepping observer design of a coupled ODE-PDE-ODE system and includes adaption to estimate the parameters of the Coulomb Stiction inclusion.

Without limitation, and in accordance with the present disclosure, the system and method for drilling may: estimate static and dynamic friction factors while drilling to help optimize the drilling operation, detect faults and unwanted incidents and aid on-site decision making; avoid or limit torsional oscillations; and, improve estimates of drill string orientation and the distribution of torque which may further enhance applications for directional drilling.

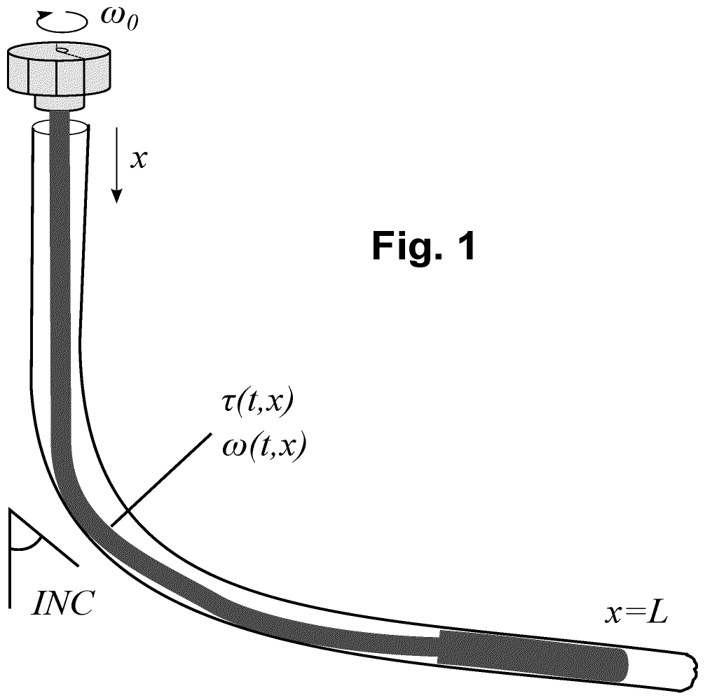

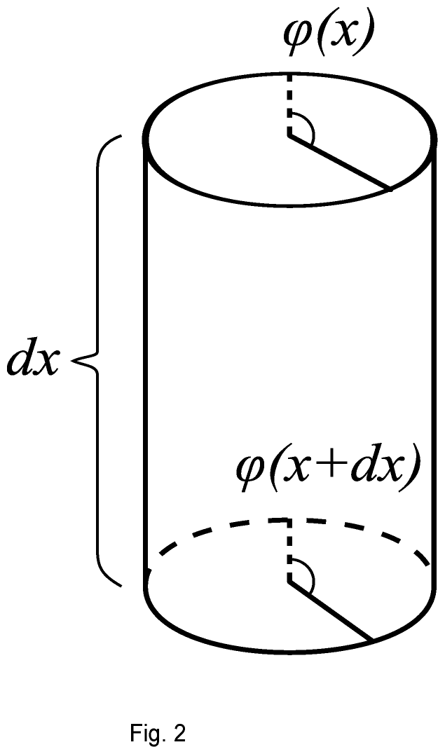

In a first embodiment of a model in accordance with the present disclosure, we use a model similar to the one proposed by Ulf Jakob F. Aarsnes and Ole Morten Aamo: Linear stability analysis of self-excited vibrations in drilling using an infinite dimensional model. Journal of Sound and Vibration, 360:239-259, January 2016. The main difference being that we only consider here the torsional dynamics. FIG. 1 shows a perspective view illustrating torsional dynamics acting on a drill string lying in a deviated bore-hole. FIG. 2 shows a model of a drill string element of the drill string of FIG. 1.

TABLE 1
Parameters

| | |
|---|---|
| a₀, a_{L}_{ₚ} | top drive, BHA frequency coefficient |
| cₜ | torsional wave velocity |
| [symbol] | Coulomb component of side force |
| G | shear modulus |
| I_{TD} | top drive inertia |
| I_{BHA} | BHA inertia |
| Jₚ, J_{c} | pipe, collar polar moment of inertia |
| kₜ | viscous component of side force |
| L | drill string length |
| Lₚ, L_{c} | pipe, collar drill string length |
| Z̅ | collar-pipe relative impedance |
| μₖ, μₛ | kinetic, static friction coefficient |
| ρ | drill string density |

p_{α} (·) , p_{β} (·) , p₀, p₁, P₀, P₁, lₛ and lₖ are observer gains.

TABLE 2
Dependent variables

| | |
|---|---|
| d | lumped side force |
| F_{N} | normal force on drill string |
| S | torque source term (side force) |
| S | Normalized source term |
| α, β | drill string Riemann invariants |
| Γ | drill string torque |
| Γₘ | motor torque |
| ∅ | drill string orientation |
| ω | drill string angular velocity |
| ω₀ | Top drive angular velocity |

The \hat{ } superscript denotes estimated quantities.
The \tilde{ } superscript denotes estimation residual.

TABLE 3
Independent variables

| | |
|---|---|
| t | time |
| x | position relative to top of drill string |

Torsional Dynamics of Drill String

Table 1 identifies parameters used throughout the present disclosure. Table 2 identifies dependent variables used throughout the present disclosure. Table 3 identifies independent variables used throughout the present disclosure.

In an embodiment of the torsional dynamic model in accordance with the present disclosure, for the angular motion, we denote the angular velocity and torque as ω(t,x), τ(t,x) which are functions of (t,x) evolving in {(t,x)| 0<t<T, x∈[0, L]} (where L is the total length of the drill string and T a positive time), see FIG. 1. The torque is found from shear strain, given as twist per unit length. Letting ϕ denote the angular displacement (see FIG. 2) in the string s.t.

$$\frac{\partial ϕ ( t , x )}{\partial t} = ω ( t , x ) ,$$

we have τ(t,x)=JG(ϕ(t,x)−ϕ(t,x+dx))/dx, where J is the polar moment of inertia and G is the shear modulus. Hence the equations for the angular motion are given by

$$\begin{matrix}\frac{\partial τ ( t , x )}{\partial t} + J G \frac{\partial ω ( t , x )}{\partial x} = 0 , & ( 1 ) \\ J ρ \frac{\partial ω ( t , x )}{\partial t} + \frac{\partial τ ( t , x )}{\partial x} = S ( t , x ) , & ( 2 )\end{matrix}$$

where the source term is due to frictional contact with the borehole and is modeled as

S(t,x)=−kₜρJω(t,x)− [symbol] (ω,τ,x), (3)

where kₜ is a constant damping term representing the viscous shear stresses between the pipe and drilling mud, and [symbol] (ω,τ,x) is a differential inclusion, that still has to be described, representing the Coulomb friction between the drill string and the borehole.

Discontinuities of a Multiple Sectioned Drill String

The lowermost section of the drill string is typically made up of drill collars which may have a great impact on the drill string dynamic due to their added inertia. In particular, the transition from the pipes to collars in the drill string will cause reflections in the travelling waves due to the change in characteristic line impedance.

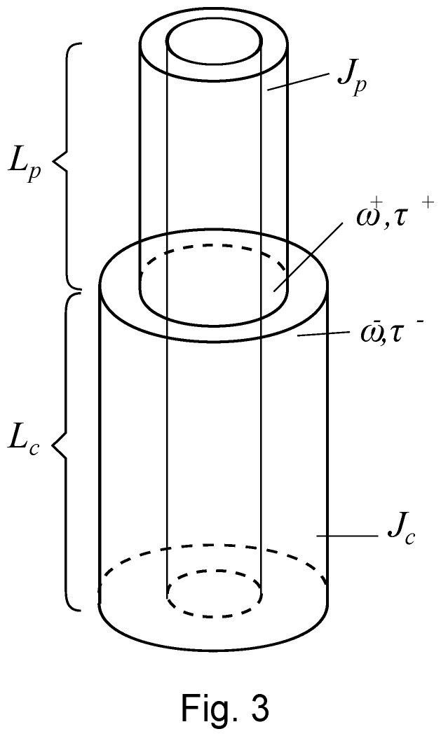

We split the drill string into a pipe section with polar moment of inertia and lengths Jₚ, Lₚ and a collar section with the same parameters given as J_{c}, L_{c}. We use τ⁺,ω⁺ to denote the strain and velocity at the top of the drill collar and τ⁻, ω⁻ at the bottom of the pipe, see FIG. 3. The boundary conditions at the transition are given by the following continuity constraints

ω⁺=ω⁻, τ⁺=τ⁻. (4)

Coulomb Friction as an Inclusion

The Coulomb friction is modeled as an inclusion

$$\{ \begin{matrix}ℱ ( ω , x ) = {μ}_{k} {F}_{N} ( x ) , & ω > {ω}_{c} , \\ ℱ ( ω , x ) ∈ [ - {μ}_{s} {F}_{N} ( x ) , {μ}_{s} {F}_{N} ( x ) ] , & \vert ω \vert < {ω}_{c} , \\ ℱ ( ω , x ) = - {μ}_{k} {F}_{N} ( x ) , & ω < - {ω}_{c} ,\end{matrix} \qquad ( 5 )$$

where F_{N} is the normal force acting between the drill string and the borehole wall, ω_{c} is the threshold on the angular velocity where the Coulomb friction switches from static to kinetic, μₛ, μₖ are the static and kinetic friction factors, respectively. Here, we distinguish between the kinetic and static friction factors: Static friction is friction between two or more solid objects that are not moving relative to each other. Kinetic friction, also known as dynamic friction or sliding friction, occurs when two objects are moving relative to each other and rub together. The function [symbol] (ω,τ,x)∈[−μₛF_{N}(x),μₛF_{N} (x)] denotes the inclusion where

$$\begin{matrix}ℱ ( ω , τ , x ) = - \frac{\partial τ ( t , x )}{\partial x} \\ - {k}_{t} ρ J ω ( t , x ) ∈ [ - {μ}_{S} {F}_{N} ( x ) , {μ}_{S} {F}_{N} ( x ) ] ,\end{matrix} \qquad ( 6 )$$

and take the boundary values ±μₛF_{N}(x) if this relation does not hold. The normal force profile of the drill string should be obtained from an appropriate torque and drag model, see e.g. S. Menand. AADE-13-FTCE-21 Borehole Tortuosity Effect on Maximum Horizontal Drilling Length Based on Advanced Buckling Modeling, In AADE National Technical Conference and Exhibition, Oklahoma, 2013.

Boundary Condition

At the topside boundary, the top drive is actuated by a motor delivering a torque τₘ which we assume to be the control input. The topdrive has the inertia I_{TD} and hence satisfies the dynamics

$$\frac{\partial {ω}_{0}}{\partial t} = \frac{1}{{I}_{T D}} ( {τ}_{m} - τ ( t , x = 0 ) ) , \qquad ( 7 )$$

and finally, the angular velocity at the top of the drill string is equal the top drive velocity ω(t,x=0)=ω₀.

Derivation of Riemann Invariants

The Riemann invariants of a Hyperbolic PDE are the states corresponding to a transformation of the system which has a diagonalized transport matrix, i.e. the system can be written as a series of transport equations only coupled through the source terms; see R. J. LeVeque: Finite volume methods for hyperbolic problems. Cambridge university press, 2002. On the set {(t,x)| 0<t<T, x∈[0, L]}, we define the Riemann invariants as

$$α = ω + \frac{{c}_{t}}{J G} τ , β = ω - \frac{{c}_{t}}{J G} τ , \\ where {c}_{t} = \sqrt{\frac{G}{ρ}} \qquad ( 8 )$$

is the velocity of the torsional wave. This transformation enables us to rewrite (1)-(2) in variables α, β as the diagonalized PDE system

$$\begin{matrix}\frac{\partial α}{\partial t} ( t , x ) + {c}_{t} \frac{\partial α}{\partial x} ( t , x ) = S ( t , x ) , & ( 9 ) \\ \frac{\partial β}{\partial t} ( t , x ) - {c}_{t} \frac{\partial β}{\partial x} ( t , x ) = S ( t , x ) . & ( 10 )\end{matrix}$$

where the source term [symbol] is defined by

$$S ( t , x ) = \frac{S ( t , x )}{J ρ} = {k}_{t} ( α ( t , x ) + β ( t , x ) ) + \frac{1}{J ρ} ℱ ( t , x ) , \qquad ( 11 )$$

where [symbol] is the inclusion given in (5) (expressed as a function of α and β). In the Riemann coordinates, the boundary conditions (4) rewrite as follows

$$\begin{matrix}{β}^{+} = \frac{1}{1 + \overline{Z}} ( {α}^{+} ( 1 - \overline{Z} ) + 2 \overline{Z} {β}^{-} ) , & ( 12 ) \\ {α}^{-} = \frac{1}{1 + \overline{Z}} ( 2 {α}^{+} + ( \overline{Z} - 1 ) {β}^{-} ) , & ( 13 )\end{matrix}$$

where we have denoted the relative magnitude of the impedance as

$$\overline{Z} = {[ \frac{{c}_{t}}{J G} ]}^{+} / {[ \frac{{c}_{t}}{J G} ]}^{-} . \qquad ( 14 )$$

The boundary condition (7) rewrites

$$\frac{\partial {ω}_{0}}{\partial t} = \frac{1}{{I}_{T D}} ( {τ}_{m} + \frac{G J}{{c}_{t}} ( β ( t , 0 ) - {ω}_{0} ( t ) ) ) . \qquad ( 15 )$$

In the case of the same material being used at both sides of the discontinuity, the only change is in the polar moment of inertia. That is, for a pipe-collar sections of e.g. steel, we have, following FIG. 3.

$$\overline{Z} = \frac{{J}_{c}}{{J}_{p}} . \qquad ( 16 )$$

Note the meaning of (12)-(13) as reflections of incoming waves from both sides, as they are split into an upward and a downward traveling wave.

Upwind Scheme

In the numerical treatment of the model, [symbol] is implemented as follows. For cell size Δx and and time step Δt, and at cell #j and time step #k

$$\begin{matrix}{\tilde{ℱ}}_{j}^{k} = \frac{1}{2 Δ t} ( {α}_{j} - {c}_{t} \frac{Δ t}{Δ x} ( {α}_{j} - {α}_{j - 1} ) + & ( 17 ) \\ {β}_{j} + {c}_{t} \frac{Δ t}{Δ x} ( {β}_{j + 1} - {β}_{j} ) + Δ t {k}_{t} ( {α}_{j}^{k} + {β}_{j}^{k} ) ) , & ( 18 )\end{matrix}$$

and limited by

$${ℱ}_{j}^{k} = \{ \begin{matrix}sgn ( {\tilde{ℱ}}_{j}^{k} ) min ( \vert {\tilde{ℱ}}_{j}^{k} \vert , {F}_{c} ) , & \frac{\vert {α}_{j}^{k} + {β}_{j}^{k} \vert}{2} \leq {ω}_{c} \\ sgn ( {\tilde{ℱ}}_{j}^{k} ) min ( \vert {\tilde{ℱ}}_{j}^{k} \vert , {f}_{r a t} {F}_{c} ) , & \frac{\vert {α}_{j}^{k} + {β}_{j}^{k} \vert}{2} > {ω}_{c}\end{matrix} \qquad ( 19 )$$

The model is updated with an upwind scheme according to

$$\begin{matrix}{α}_{j}^{k + 1} = {α}_{j}^{k} - {c}_{t} \frac{Δ t}{Δ x} ( {α}_{j}^{k} - {α}_{j - 1}^{k} ) - Δ t {k}_{t} ( {α}_{j}^{k} + {β}_{j}^{k} ) - {ℱ}_{j}^{k} & ( 20 ) \\ {β}_{j}^{k + 1} = {β}_{j}^{k} - {c}_{t} \frac{Δ t}{Δ x} ( {β}_{j}^{k} - {β}_{j + 1}^{k} ) - Δ t {k}_{t} ( {α}_{j}^{k} + {β}_{j}^{k} ) - {ℱ}_{j}^{k} . & ( 21 )\end{matrix}$$

Model Validity

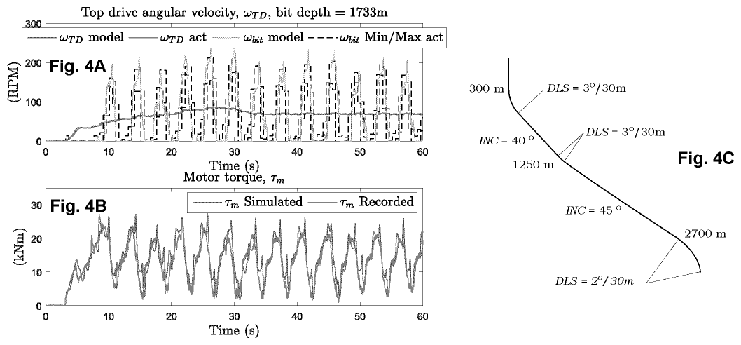

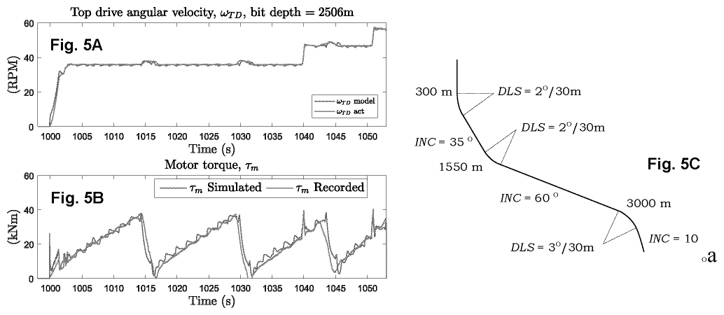

Here, we briefly discuss the effectiveness of the present modeling approach by briefly considering the open-loop fit of the model to full scale field data shown in FIGS. 4A-4C and FIGS. 5A-5C.

In both the cases of FIGS. 4A-4C and FIGS. 5A-5C, the model accurately replicates the stick slip oscillations of the field data. The cases covers two qualitatively different behavior of the stick slip, demonstrating a certain degree of versatility of the model. In particular we note that, for FIGS. 4A-4C where down-hole data is available, a good replication of the angular BHA velocity is also achieved. Down-hole data for the well in FIGS. 5A-5C is not available.

These fits were achieved by tuning the friction factors of the model to get the simulation results to match the data. The model is capable to replicate the full scale field dynamics in most cases when this tuning is good. The goal of the present paper is to obtain an automated algorithm, the adaptive observer (a.k.a. soft sensor), which performs this tuning online. The design and testing of this adaptive observer is done in the following.

Semi-Lumped Approximation

In this section we derive a model for observer design by using a lumped approximation of the drill collar section. This amenable model approximation will be used for the observer design.

Lumped BHA

The approximation entails lumping the effect of the source term (11) into the lumped dynamics of the BHA. This is a reasonable approximation for many drill-strings as much of the torque acting on the drill string will come from stabilizers located in, or close to, the BHA; see U. J. F Aarsnes, F. Di Meglio, and R. J. Shor. Avoiding stick slip vibrations in drilling through startup trajectory design; Journal of Process Control, 70:24-35, October 2018. The inertia of the lumped BHA is

I_{BHA}−ρL_{c}J_{c}, (22)

and hence the angular velocity of the BHA is governed by

$$\frac{\partial {ω}_{{L}_{p}}}{\partial t} = \frac{1}{{I}_{B H A}} ( τ ( t , x = {L}_{p} ) - d ( t ) ) , \qquad ( 23 )$$

where d(t) accounts for the now lumped effect of the distributed source term, i.e.:

d(t)≈∫₀^{L}S(ω,x). (24)

Here, (24) is meant for illustration and is not used directly. When we later employ the flat formulation, facilitated by this approximation, for estimation d(t) will be treated as an uncertain disturbance.

Using this lumped approximation of BHA, we obtain what we will refer to as the semi-lumped formulation, given by the distributed wave-equation for the pipe section

$$\begin{matrix}\frac{\partial {τ}_{p} ( t , x )}{\partial t} + J G \frac{\partial {ω}_{p} ( t , x )}{\partial x} = 0 , & ( 25 ) \\ {J}_{p} ρ \frac{\partial {ω}_{p} ( t , x )}{\partial t} + \frac{\partial {τ}_{p} ( t , x )}{\partial x} = 0 , & ( 26 )\end{matrix}$$

defined on {(t,x)| 0<t<T, x∈[0, Lₚ]} with the boundary conditions ωₚ(t, x=0)=ω₀, ωₚ(t, x=Lₚ)=ωLₚ governed by

$$\begin{matrix}\frac{\partial {ω}_{0}}{\partial t} = \frac{1}{{I}_{T D}} ( {τ}_{m} - {τ}_{p} ( t , x = 0 ) ) , & ( 27 ) \\ \frac{\partial {ω}_{{L}_{p}}}{\partial t} = \frac{1}{{I}_{B H A}} ( {τ}_{p} ( t , x = {L}_{p} ) - d ( t ) ) . & ( 28 )\end{matrix}$$

The fit of this approximation and how to quantify any resulting error is discussed in U. J. F Aarsnes, F. Di Meglio, and R. J. Shor; Avoiding stick slip vibrations in drilling through startup trajectory design. Journal of Process Control, 70:24-35, October 2018.

In Riemann Invariants

Using the Riemann Variables (α,β) as states, the semi-lumped system (25)-(28) defined on {(t,x)| 0<t<T, x∈[0, Lₚ]}, rewrites:

$$\begin{matrix}\frac{\partial {α}_{p}}{\partial t} ( t , x ) + {c}_{t} \frac{\partial {α}_{p}}{\partial x} ( t , x ) = 0 , & ( 29 ) \\ \frac{\partial {β}_{p}}{\partial t} ( t , x ) - {c}_{t} \frac{\partial {β}_{p}}{\partial x} ( t , x ) = 0 , & ( 30 )\end{matrix}$$

with the boundary conditions

$$\begin{matrix}{β}_{p} ( t , {L}_{p} ) = 2 {ω}_{{L}_{p}} ( t ) - {α}_{p} ( t , {L}_{p} ) , & ( 31 ) \\ {α}_{p} ( t , 0 ) = 2 {ω}_{0} ( t ) - {β}_{p} ( t , 0 ) , & ( 32 ) \\ \frac{\partial {ω}_{0}}{\partial t} ( t ) = {a}_{0} ( - {ω}_{0} ( t ) + {β}_{p} ( t , 0 ) ) + \frac{1}{{I}_{T D}} {τ}_{m} ( t ) & ( 33 ) \\ \frac{\partial {ω}_{{L}_{p}}}{\partial t} ( t ) = {a}_{{L}_{p}} ( - {ω}_{{L}_{p}} ( t ) + {α}_{p} ( t , {L}_{p} ) ) - \frac{1}{{I}_{B H A}} d , & ( 34 )\end{matrix}$$

where the frequency constants given as

$${a}_{0} = \frac{{G}_{p} {J}_{p}}{{c}_{t} {I}_{T D}} and {a}_{{L}_{p}} = \frac{{G}_{p} {J}_{p}}{{c}_{t} {I}_{B H A}} .$$

They are expressed in seconds' and they respectively represent the inertia of the top-drive and BHA, relative to the line impedance of the pipe section of the drill string

$${ζ}_{p} = \frac{{G}_{p} {J}_{p}}{{c}_{t}} .$$

The solution to (29)-(30) can be written as the delay equations:

αₚ(t,x=Lₚ)=αₚ(t−t_{D},x0) (35)

βₚ(t,x=0)=βₚ(t−t_{D},x=Lₚ), (36)

where t_{D}=Lₚ/cₜ. Thus, we note that this system is characterized by three time constants
1/a₀: Top drive time constant.
1/a_{L}_{ₚ}: BHA time constant.
t_{D}: Drill string travel time.

Soft Sensor (Observer) Design

The core of the approach is a ‘soft-sensor’ combining measurements from physical sensors with a model of the system dynamics to provide estimates of states and side-forces. The soft-sensor is based on an observer algorithm. Observers are dynamical systems whose states are the estimates of the aforementioned variables. The observer state dynamics are a combination of
‘open-loop’ terms based on the equations of physics describing the behavior of the system.
‘closed-loop’ terms that correct the dynamics based on the value of the measurements. Typically, the value from the sensors are compared with their estimates from the observer, and a function of the discrepancy between the two are added as a correction term.

The task of design an observer is to engineer the combination of ‘open-loop’ and closed-loop correction terms. Often, the correction terms are linear function of the estimation error of the measured states. These correction terms are then used to update the estimated states as new measurement data become available. In our case, they appear in the observer dynamics as spatially-varying and lumped gains called observer gains. We will use the specific observer gains using a backstepping method which guarantees fast and robust convergence of the estimates assuming the model is correct. More precisely, a proof of asymptotic convergence of the estimates to the true states can be found for the linearised dynamics, i.e. close to the constant homogeneous velocity profile.

The soft sensor is adaptive in that it estimates the side forces and then updates the observer model kinetic or static friction factor iteratively for each time step depending on if the drill string BHA is stuck or sliding. The algorithm presented here is not able to simultaneously update the transition velocity ω_{c} in (5), hence this value has to be fixed. We remark that it is known that this transition velocity can have a significant impact on model behavior in some cases, which might limit the performance of the proposed algorithm.

Observer System Equations

The observer equations are given as a copy of the plant equations plus the correction terms. The measured output of the system corresponds to the top drive angular velocity ω₀.

We denote an estimated variable with the “\hat{ }” superscript. We define the measured estimation error as: e=\hat{ω}₀−ω₀.

In the following p_{α}(⋅), p_{β}(⋅), p₀, p₁, P₀, P₁, lₛ and lₖ denote the observer gains, which still have to be defined. The estimation of the top drive angular velocity is given by

$${\dot{\hat{ω}}}_{0} = {a}_{0} ( {\hat{β}}_{p} ( t , 0 ) - {\hat{ω}}_{0} ) + \frac{1}{{I}_{T D}} {τ}_{m} - {p}_{0} e , \qquad ( 37 )$$

For the pipe section, the estimation of the Riemann invariant is given by

$$\begin{matrix}\frac{\partial {\hat{α}}_{p}}{\partial t} ( t , x ) + {c}_{t} \frac{\partial {\hat{α}}_{p}}{\partial x} ( t , x ) = {\hat{𝒮}}_{p} ( t , x ) - {p}_{α} ( x ) e , & ( 38 ) \\ \frac{\partial {\hat{β}}_{p}}{\partial t} ( t , x ) - {c}_{t} \frac{\partial {\hat{β}}_{p}}{\partial x} ( t , x ) = {\hat{𝒮}}_{p} ( t , x ) - {p}_{β} ( x ) e . & ( 39 )\end{matrix}$$

For the collar section, the estimation of the Riemann invariant is given by

$$\begin{matrix}\frac{\partial {\hat{α}}_{c}}{\partial t} ( t , x ) + {c}_{t} \frac{\partial {\hat{α}}_{c}}{\partial x} ( t , x ) = {\hat{𝒮}}_{c} ( t , x ) - {p}_{1} e , & ( 40 ) \\ \frac{\partial {\hat{β}}_{c}}{\partial t} ( t , x ) - {c}_{t} \frac{\partial {\hat{β}}_{c}}{\partial x} ( t , x ) = {\hat{𝒮}}_{c} ( t , x ) - {p}_{1} e . & ( 41 )\end{matrix}$$

Finally, the boundary conditions are

$$\begin{matrix}{\hat{α}}_{p} ( t , 0 ) = 2 {\hat{ω}}_{0} ( t ) - {\hat{β}}_{p} ( t , 0 ) - {P}_{0} e , & ( 42 ) \\ {\hat{β}}_{p} ( t , {L}_{p} ) = \frac{{\hat{α}}_{p} ( t , {L}_{p} ) ( 1 - \overline{Z} ) + 2 \overline{Z} {\hat{β}}_{c} ( t , {L}_{p} )}{1 + \overline{Z}} - {P}_{1} e & ( 43 ) \\ {\hat{α}}_{c} ( t , {L}_{p} ) = \frac{2 {\hat{α}}_{p} ( t , {L}_{p} ) - {\hat{β}}_{c} ( t , {L}_{p} ) ( 1 - \overline{Z} )}{1 + \overline{Z}} & ( 44 ) \\ {\hat{β}}_{c} ( t , L ) = - {\hat{α}}_{c} ( t , L ) & ( 45 )\end{matrix}$$

The source term in each section are computed from the estimated states and friction factors

$${\hat{𝒮}}_{i} ( t , x ) = \frac{\hat{S} ( t , x )}{{J}_{i} ρ} = {k}_{t} ( {\hat{α}}_{i} ( t , x ) + {\hat{β}}_{i} ( t , x ) ) + \frac{1}{{J}_{i} ρ} ℱ ( t , x ) , \qquad ( 46 )$$

where [symbol] (t,x) is the inclusion given in (5), and the estimates of the friction factor is updated according to

$$\begin{matrix}{\dot{\hat{μ}}}_{s} ( t ) = \{ \begin{matrix}- {l}_{s} e , & \vert {\hat{ω}}_{{L}_{p}} \vert \leq {ω}_{c} , \\ 0 , & \vert {\hat{ω}}_{{L}_{p}} \vert > {ω}_{c}\end{matrix} , & ( 47 ) \\ {\dot{\hat{μ}}}_{k} ( t ) = \{ \begin{matrix}0 , & \vert {\hat{ω}}_{{L}_{p}} \vert \leq {ω}_{c} , \\ {l}_{k} e , & \vert {\hat{ω}}_{{L}_{p}} \vert > {ω}_{c}\end{matrix} , & ( 48 )\end{matrix}$$

Finally, the following saturation is used to improve robustness of the method:

\hat{μ}ₛ=max(\hat{μ}ₛ,\hat{μ}ₖ). (49)

The initial condition of (37)-(45) can be arbitrarily chosen.

Semi-Lumped Approximation and Error System

We want to design the observer gains using the approach proposed in F. Di Meglio, P.-O. Lamare, and U. J. F. Aarsnes. Robust output feedback stabilization of an ODE-PDE-ODE interconnection; Submitted, (October):1-11, 2018, to ensure the convergence of the observer state (solution of (37)-(45)) to the real state (solution of (9)-(15)). To do so, we need to rewrite the observer system in a suitable form (i.e. without the inclusion). This is done using the lumped approximation of the drill collar section introduced elsewhere in the present disclosure. More precisely, the observer dynamics (37)-(45) can be rewritten

$$\begin{matrix}{\dot{\hat{ω}}}_{0} ( t ) = {a}_{0} ( {\hat{β}}_{p} ( t , 0 ) - {\hat{ω}}_{0} ( t ) ) + \frac{1}{{I}_{T D}} {τ}_{m} - {p}_{0} e , & ( 50 ) \\ \frac{\partial {\hat{α}}_{p}}{\partial t} ( t , x ) + {c}_{t} \frac{\partial {\hat{α}}_{p}}{\partial x} ( t , x ) = - {p}_{α} ( x ) e , & ( 51 ) \\ \frac{\partial {\hat{β}}_{p}}{\partial t} ( t , x ) - {c}_{t} \frac{\partial {\hat{β}}_{p}}{\partial x} ( t , x ) = - {p}_{β} ( x ) e , & ( 52 ) \\ {\dot{\hat{ω}}}_{{L}_{p}} ( t ) = {a}_{{L}_{p}} ( {\hat{α}}_{p} ( t , {L}_{p} ) - {\hat{ω}}_{{L}_{p}} ( t ) ) - \frac{1}{{I}_{B H A}} \hat{d} - {p}_{1} e , & ( 53 )\end{matrix}$$

with the boundary conditions

\hat{α}ₚ(t,0)=2\hat{ω}₀(t)−\hat{β}ₚ(t,0)−P₀e, (54)

\hat{β}ₚ(t,Lₚ)=2\hat{ω}_{L}_{ₚ}(t)−\hat{α}ₚ(t,Lₚ)−P₁e, (55)

The term \hat{d} accounts for the now lumped effect of the distributed source term (obviously depending on the expression given in (46)). For the design of observer gains, we consider the term d as a constant lumped disturbance, normalized by

$$\frac{{I}_{B H A}}{{\int }_{0}^{L} {F}_{N} ( x ) d x}$$

(thus, \hat{d} is also assumed to be constant). Subtracting system (29)-(75) from system (50)-(55) and denoting the error variables with the \tilde{⋅} superscript (i.e \tilde{α}ₚ=\hat{α}ₚ−αₚ for instance), we get the following error system

$$\begin{matrix}{{ω}^{\dot{\sim}}}_{0} ( t ) = {a}_{0} ( {\tilde{β}}_{p} ( t , 0 ) - e ) - {p}_{0} e & ( 56 ) \\ \frac{\partial {\tilde{α}}_{p}}{\partial t} ( t , x ) + {c}_{t} \frac{\partial {\tilde{α}}_{p}}{\partial x} ( t , x ) = - {p}_{α} ( x ) e , & ( 57 ) \\ \frac{\partial {\tilde{β}}_{p}}{\partial t} ( t , x ) - {c}_{t} \frac{\partial {\tilde{β}}_{p}}{\partial x} ( t , x ) = - {p}_{β} ( x ) e , & ( 58 ) \\ {{ω}^{\dot{\sim}}}_{{L}_{p}} ( t ) = {a}_{{L}_{p}} ( {\tilde{α}}_{p} ( t , {L}_{p} ) - {\tilde{ω}}_{{L}_{p}} ( t ) ) - {p}_{1} e - \frac{1}{{I}_{B H A}} \tilde{d} , & ( 59 ) \\ \dot{\tilde{d}} = 0 , & ( 60 )\end{matrix}$$

with the boundary conditions

\tilde{α}ₚ(t,0)=2\tilde{ω}₀(t)−\tilde{β}ₚ(t,0)−P₀e, (61)

βₚ(t,Lₚ)=2\tilde{ω}_{L}_{ₚ}(t)−\tilde{α}ₚ(t,Lₚ)−P₁e, (62)

Control Dual Problem

The backstepping approach proposed in F. Di Meglio, P.-O. Lamare, and U. J. F. Aarsnes. Robust output feedback stabilization of an ODE-PDE-ODE interconnection; Submitted, (October):1-11, 2018, provides an explicit method to design a robust output feedback boundary control law for an ODE-PDE-ODE interconnection. However, it has been proved in J. Auriol and F. Di Meglio. Two-sided boundary stabilization of heterodirectional linear coupled hyperbolic pdes, IEEE Trans-actions on Automatic Control, 63(8):2421-2436, 2018, that the gains of such a control law correspond to the gain of the observer of the dual problem (this has actually been proved in the case of a system of n+m PDEs, but the proof can be easily adjusted to an ODE-PDE-ODE interconnection). More precisely, adjusting the methods proposed in J. Auriol and F. Di Meglio, Two-sided boundary stabilization of heterodirectional linear coupled hyperbolic pdes, IEEE Trans-actions on Automatic Control, 63(8):2421-2436, 2018, we can prove that the system (56)-(62) has the same stability properties as those of the system defined on {(t,x)| 0<t<T, x∈[0, 1]} by

$$\begin{matrix} \frac{\partial ψ}{\partial t} ( t , x ) - \frac{{c}_{t}}{{L}_{p}} \frac{\partial ψ}{\partial x} ( t , x ) = 0 , & ( 63 ) \\ \frac{\partial ϕ}{\partial t} ( t , x ) + \frac{{c}_{t}}{{L}_{p}} \frac{\partial ϕ}{\partial x} ( t , x ) = 0 , & ( 64 ) \\ {\dot{χ}}_{0} ( t ) = 2 \frac{{c}_{t}}{{L}_{p}} ψ ( t , 0 ) - {a}_{0} {χ}_{0} - {p}_{0} {χ}_{0} ( t ) - {p}_{1} {χ}_{1} ( t ) - {P}_{0} {c}_{t} ψ ( t , 0 ) - {P}_{1} {c}_{t} ϕ ( t , {L}_{p} ) - {\int }_{0}^{{L}_{p}} {p}_{α} ( ξ ) ψ ( t , ξ ) + {p}_{β} ( ξ ) ϕ ( t , ξ ) d ξ , & ( 65 ) \\ {\dot{χ}}_{1} ( t ) = 2 \frac{{c}_{t}}{{L}_{p}} ϕ ( t , 1 ) - {a}_{{L}_{p}} {χ}_{1} ( t ) , & ( 66 ) \\ {\dot{χ}}_{2} ( t ) = - \frac{1}{{I}_{B H A}} {χ}_{1} ( t ) , & ( 67 )\end{matrix}$$

with the boundary conditions

$$\begin{matrix}ψ ( t , 1 ) = - ϕ ( t , 1 ) + \frac{{L}_{p}}{{c}_{t}} {a}_{{L}_{p}} {χ}_{1} ( t ) , & ( 68 ) \\ ϕ ( t , 0 ) = - ϕ ( t , 0 ) + \frac{{L}_{p}}{{c}_{t}} {a}_{0} {χ}_{0} ( t ) & ( 69 )\end{matrix}$$

This new system (which is the adjoint of (56)-(62)) has exactly the structure which is considered in J. Auriol and F. Di Meglio, Two-sided boundary stabilization of heterodirectional linear coupled hyperbolic pdes. IEEE Trans-actions on Automatic Control, 63(8):2421-2436, 2018. This immediately gives us the expression of the observer gains (we choose to not rewrite them here for sake of clarity). More precisely, these observer gains only depends on three tuning parameters (namely, η₁, z and p) that can be tuned to shape the observer top-side reflection and place the poles of the down-hole “error system”. Considering the adaptive update law, the gain lₖ, is derived from the observer assuming a constant lumped disturbance, and then normalized by

$$\frac{{I}_{B H A}}{{\int }_{0}^{L} {F}_{N} ( x ) d x} .$$

The gain for the update law of the static friction factor is then chosen to be two times this lₛ=2lₖ. With these gains we can ensure the convergence of the observer states to the real states in presence of a constant disturbance. One must be aware that this assumption is only an approximation and does not hold in the real case. However, due to the robustness properties of the observer, we can still have the convergence of the different states to their real values when considering the real inclusion term. Considering the estimations of the friction terms, we do not have any guarantee of convergence, but, due to the robustness properties of the observer, they should converge close to the real friction terms. This is experimentally validated in the next section.

Field Application

The observer detailed in the previous section may be used to provide online parameter estimation for the friction parameters of the drillstring model presented above can also be used as a method to estimate BHA rotation and torque. This can be of particular usefulness in directional drilling scenarios where real-time estimation of tool face angle—BHA angular orientation—is essential, and in feedforward stick-slip mitigation systems.

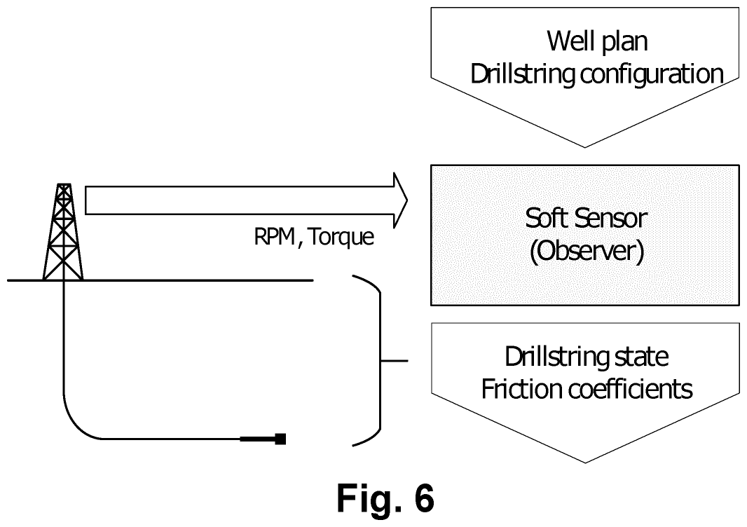

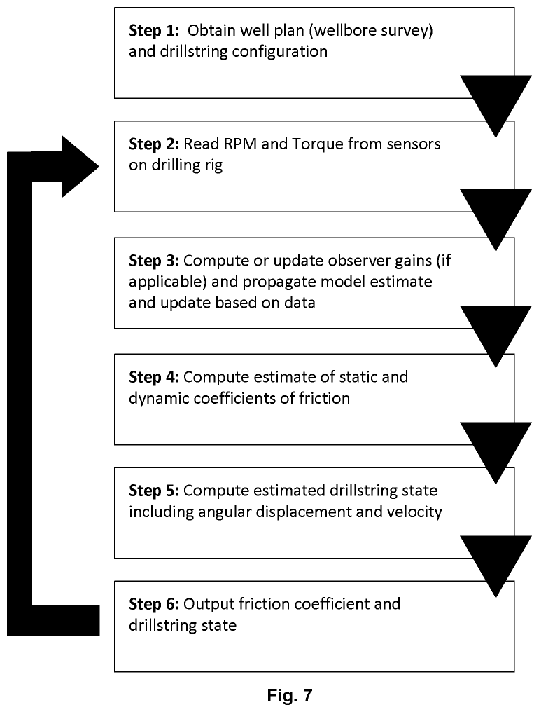

The envisioned industrial implementation of the estimation algorithm is briefly described in this section. The flow of data is show in FIG. 6 and a flowchart describing the process is presented in FIG. 7.

Output of the estimation algorithm may include an estimate of the drillstring state as a function of measure depth, and a time series of the friction coefficient, estimated drillstring twist and the soft sensor (observer) gains.

We now consider a test of the estimation algorithm (37)-(48). We want to evaluate the real time estimation of the friction coefficients and of the BHA and top drive rotation in two different situations: (1) comparison against a simulation model (2) comparison against field data. In each situation, we run the observer using high frequency measurements (100 Hz) but also downsampled 5 Hz and 1 Hz measurements. These examples are of particular note since a majority of supervisory control systems currently deployed on drilling rigs in the field operate at 5 to 10 Hz.

Test Against Simulation Model

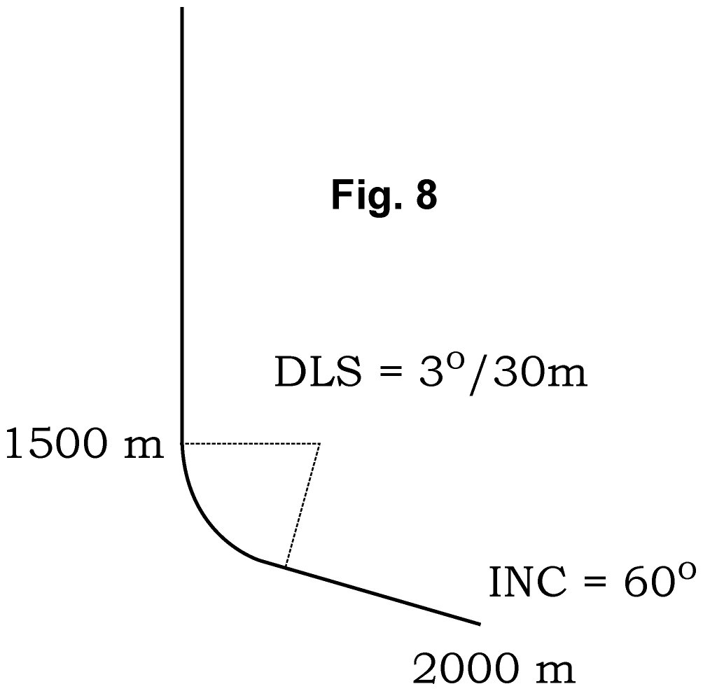

We test our observer against the simulation model with the wellbore survey shown in FIG. 8, using the numerical implementation described elsewhere in the present disclosure.

The kinetic friction is chosen to be equal to 0.187, while the static friction is chosen to be equal to 0.6 which is similar to values reported using traditional friction tests in the field. The well represents a simple build and hold well used throughout the world.

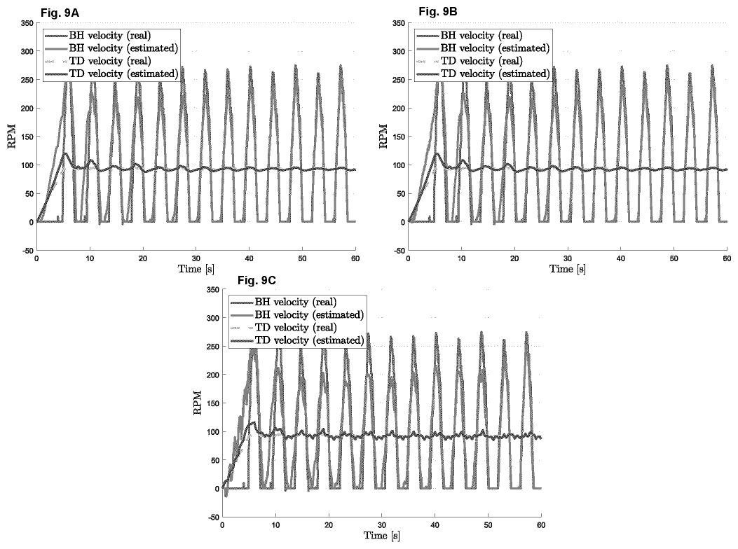

We have pictured in FIGS. 9A-9C the real value of the BHA angular velocity and of the top drive angular velocity as well as the estimations obtained using the observer in three different situations. In FIG. 9A, the measurements are available every 0.01 s (100 Hz), while in the two next plots they are only available every 0.2 s (5 Hz), resp. 1 s (1 Hz)). This means that for the cases with lower sampling rates, the observer correction term is less frequently updated, which we would expect to potentially reduce convergence rate or accuracy. As is seen in FIGS. 9A and 9B, the 100 and 5 Hz cases show a rapid convergence of the estimated states to the correct trajectories, while at 1 Hz sampling rate the performance has started to degrade.

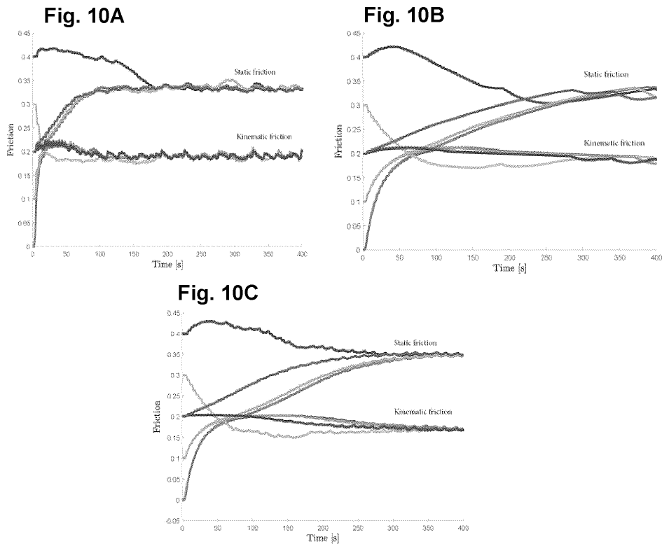

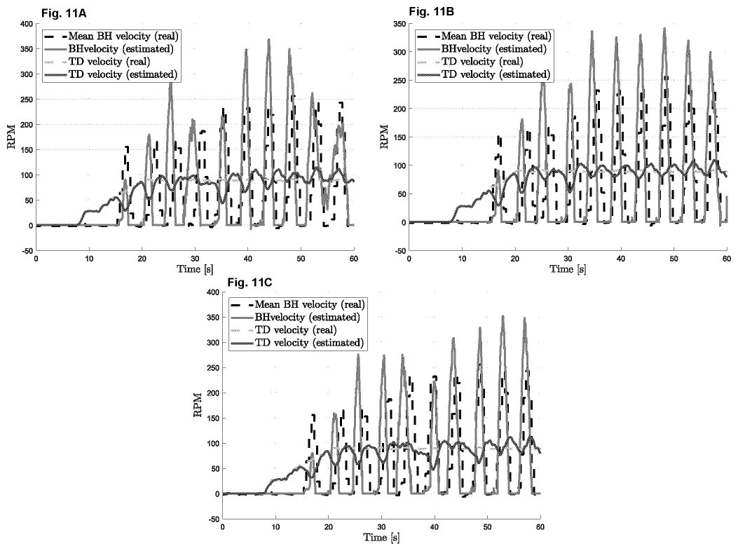

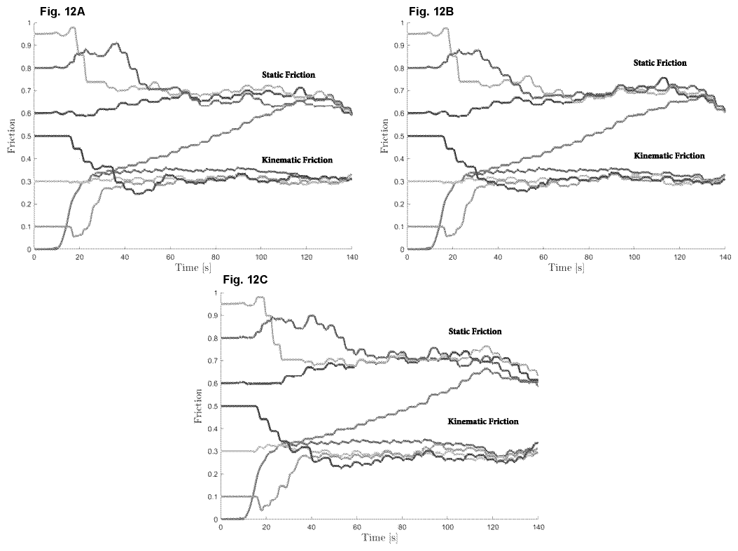

We have pictured in FIGS. 10A-10C, the estimation given by the observer of the friction parameters for different starting points in the three different situations (100 Hz, 5 Hz and 1 Hz measurements). In the two first cases, we have a rapid convergence of the estimations regardless of the initial guess. However, the convergence value (in particular for the static friction term) may not exactly correspond to the exact one (even if it remains close). In the last case (1 Hz measurements), the estimations of the friction terms oscillate around the exact value. The estimations remain good however.

Test on Field Data

We now test our observer against field data obtained from an onshore well with the wellpath shown in FIGS. 4A-4C. Surface rpm and torque data was recorded at 100 Hz using a high frequency data recorder and downhole data in the BHA was recorded on a memory tool as a 10 second windowed minimum, maximum and average value. RPM data was obtained using an encoder at surface and via magnetometer/accelerometer data downhole. Surface torque data was obtained from current integration in the inverter controller the topdrive and pipe torque was inferred by removing inertial acceleration torque. Top drive inertia was obtained using a chirp test. We have pictured in FIGS. 11A-11C the real mean value of the BHA angular velocity and of the top drive angular velocity as well as the estimations obtained using the observer, again for the three cases of 100 Hz, 5 Hz and 1 Hz data sampling rates. Once again, the observer is run at a frequency of 100 Hz, possibly using the same value of the output for successive iterations in the two latter cases. In the three cases, the estimations provided by the observer tends to convergence to the real values. Note that the field data can be unsynchronized and that we don't take here the possible offset into account. Then we cannot really compare the phases of the field data/estimated angular velocities but only their respective magnitudes.

We have pictured in FIGS. 12A-12C the estimation given by the observer of the friction parameters for different starting points in the three different situations (100 Hz, 5 Hz and 1 Hz measurements). In the three cases the estimations converge to the same values (0.6 for the static friction and 0.35 for the kinetic friction) regardless of the initial guess.

Tracking and Control

Model for Control Design

To simplify analysis and controller design, it is an amenable approximation to represent the BHA section of the drill string, including the collar section, as a single lumped inertial element. The inertia of the lumped BHA is

I_{BHA}=μL_{c}L_{c} (70)

Now, we define the frequency constants

$${a}_{0} = \frac{{ζ}_{p}}{{I}_{T D}} and {a}_{L} = \frac{{ζ}_{p}}{{I}_{B H A}} ,$$

both with dimensions seconds⁻¹, representing the inertia of the top-drive and BHA, respectively, relative to the line impedance of the drill string ζₚ. Then, we will express the solution of (9)-(10) as delay equations. This approximation entails lumping the effect of the source term (11) into the lumped dynamics of the BHA. This is a reasonable approximation for most drill-strings as much of the torque acting on the drill string will come from stabilizers located in, or close to, the BHA. The delay equations write:

α_{L}(t)=α₀(t−D), β₀(t)=β_{L}(t−D). (71)

where D=Lₚ/cₜ. The semi-lumped approximation of the dynamics then writes as

$$\begin{matrix}{β}_{L} = 2 {ω}_{L} - {α}_{0} ( t - D ) & ( 72 ) \\ {α}_{0} = 2 {ω}_{0} - {β}_{L} ( t - D ) & ( 73 ) \\ {\dot{ω}}_{0} = {a}_{0} ( - {ω}_{0} + {β}_{L} ( t - D ) ) + \frac{1}{{I}_{T D}} {τ}_{m} & ( 74 ) \\ {\dot{ω}}_{L} = {a}_{L} ( - {ω}_{L} + {α}_{0} ( t - D ) ) + \frac{1}{{I}_{B H A}} d . & ( 75 )\end{matrix}$$

We note that this system is characterized by the three time constants
1/a₀: Top drive time constant.
1/a_{L}: BHA time constant.
D: Drill string travel time.

Control Architecture

The control signal is composed of three terms:

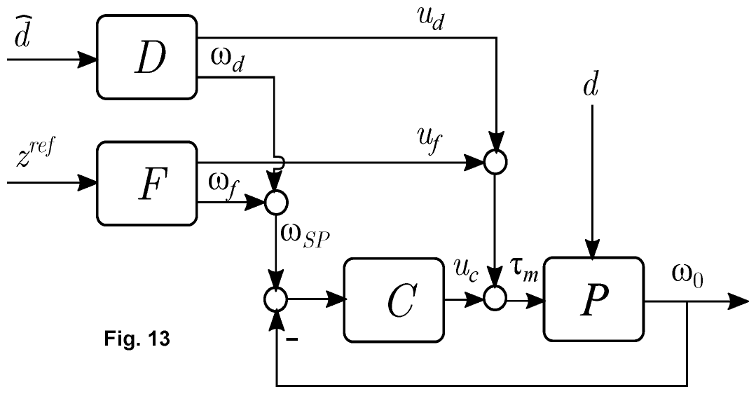

τₘₘ=u_{c}+u_{f}+u_{d}, (76)

where u_{c}(t)=−(C*(ω_{SP}−ω₀))(t) is a feedback term, u_{f} is a feed-forward term to ensure tracking and u_{d}=(D*\hat{d}) a disturbance canceling term, with the controller impulses C(t), D(t) to be designed. This conforms to a canonical 3DOF controller architecture, see FIG. 13. The set-point for the top drive velocity ω_{SP} is generated as the sum of the disturbance and the tracking feed-forward terms ω_{d} and ω_{f}. The disturbance feed-forward term ω_{d} is needed since the disturbance canceling imposes a trajectory on the top drive velocity. The feed-forward tracking term is design so as to avoid sustained oscillations of the BHA by exploiting the models differential flatness. Since these feed-forward terms are initiated as the drill string breaks free from the static friction, the system dynamics are linear and the two terms can be superpositioned.

Baseline Feedback Control: SoftSpeed/SoftTorque

The current industry standard in handling torsional vibrations are the two products NOV's SoftSpeed (A. Kyllingstad, P. J. Nessjøen, A new stick-slip prevention system, Proc. SPE/IADC Drill. Conf. Exhib. No. (2009, March) 17-19.) and Shell's SoftTorque (S. Dwars, Recent advances in soft torque rotary systems, in: Proc. 2015SPE/IADC Drill. Conf. No., London, United Kingdom, 2015, March, pp. 17-19.) The essential approach of all solutions is to reduce the reflection coefficient at the top drive in a certain key frequency range.

Assuming for the moment a constant set-point, and defining the controller transfer function

$$C ( s ) ≡ \frac{{τ}_{m}}{{ω}_{0}}$$

we obtain the relation:

$$\frac{{τ}_{0} ( s )}{{ω}_{T D} ( s )} = C ( s ) + {I}_{T D} s ≡ \overline{C} ( s ) , \qquad ( 77 )$$

while the topside reflection coefficient is given as:

$$R ( ω ) = {\vert \frac{\overline{C} ( s ) - {ζ}_{p}}{\overline{C} ( s ) + {ζ}_{p}} \vert}_{s = j ω} . \qquad ( 78 )$$

Typically, a PI or PID controller is employed, that is, on the form

τₘ=Kₚe+Kᵢ∫₀^{t}e(ξ)dξ+K_{d}ė (79)

e=ω_{TD}−ω_{SP}, (80)

This results in the feedback relation

$$\overline{C} ( s ) = {K}_{p} + \frac{{K}_{i}}{s} + ( {K}_{d} + {I}_{T D} ) s , \qquad ( 81 )$$

that is

$$R ( ω ) = {\vert \frac{{K}_{p} - {ζ}_{p} + \frac{{K}_{i}}{s} + ( {K}_{d} + {I}_{T D} ) s}{{K}_{p} + {ζ}_{p} + \frac{{K}_{i}}{s} + ( {K}_{d} + {I}_{T D} ) s} \vert}_{s = j ω}$$

where-from we see that impedance matching (R≈0) is obtained with the tuning:
1. Kₚ=ζₚ to match drill string impedance.
2. Kᵢ small but non-zero (to achieve tracking).
3. K_{d}=−I_{TD} to counter-act the effect of the top drive inertia.

The problem with this approach is that −K_{d}>I_{TD} leads to instability, while −K_{d}<I_{TD} rapidly degrades performance. Furthermore, the high K_{d} term leads to excessive noise sensitivity. The approach of Softspeed is to remove the negative integral-action altogether, set the proportional action to

Kₚ=4ζₚ, (83)

and then tune the integral gain according to

Kᵢ=(2πf_{c})²I_{TD}², (84)

where f_{c} is the frequency (in Hertz) where the minimum of R(ω) is achieved.

For the PID controller, minimum of the reflection coefficient is obtained at

$${arg min}_{ω} R ( ω ) = \sqrt{\frac{{K}_{i}}{{I}_{T D} + {K}_{d}}} ≡ {f}_{c} 2 π . \qquad ( 85 )$$

In the following we will use the SoftTorque-like controller, (83),(84) as our baseline controller, as this type of controller is the most widely used of the stick-slip mitigating controllers in the field. It is worth noting that the industry standard controller that is most often used is a high gain PI control to ensure rapid tracking of the top drive set-point. We will also consider this kind of controller for comparisons and will in this case use the gains

Kₚ=100ζₚ, Kᵢ=5I_{TD}. (86)

Disturbance Cancellation

Note from (72)-(75) that the down-hole velocity ω_{L}, which is what we want to control and keep constant, is the signal α₀ delayed and low-pass filtered. Hence, ω_{L} can be controlled by controlling α₀. We have

$$\begin{matrix}{α}_{0} = 2 {ω}_{0} - {β}_{0} & ( 87 ) \\ = \frac{2}{s + {a}_{0}} \frac{{u}_{d}}{{I}_{T D}} + \frac{s - {a}_{0}}{s + {a}_{0}} {β}_{0} & ( 88 ) \\ = \frac{2}{s + {a}_{0}} \frac{{u}_{d}}{{I}_{T D}} + \frac{s - {a}_{0}}{s + {a}_{0}} \frac{2 {e}^{- s D}}{s + {a}_{L}} \frac{d}{{I}_{B H A}} . & ( 89 )\end{matrix}$$

Hence, to try to cancel the effect of the disturbance, we will use the disturbance canceling term

$${u}_{d} = - \frac{s - {a}_{0}}{s + {a}_{L}} \frac{{a}_{L}}{{a}_{0}} {e}^{- s D} \hat{d} ( t ) , \qquad ( 90 )$$

where \hat{d} is an estimate of the disturbance.

This disturbance canceling term results in the following contribution to the top drive velocity set-point

$${ω}_{d} = \frac{1}{s + {a}_{L}} \frac{{e}^{- s D}}{{I}_{B H A}} \hat{d} ( t ) . \qquad ( 91 )$$

Estimating the Disturbance Magnitude

The disturbance will be assumed to take the form of a Heaviside step function acting the instant the BHA releases from the stick phase. Hence, the task of estimating the disturbance equates to estimating the offset time and magnitude of this function. Considering the case of a stick slip limit cycle being initiated for a industry standard high-gain PI controller, the controller keeps the topdrive angular velocity ω₀ approximately constant, while the changes in motor torque τₘ is due to the disturbance, see FIGS. 4A-4C and 5A-5C. We have

$${Δτ}_{m} = - \frac{{a}_{L}}{s + {a}_{L}} 2 {e}^{- s D} d ( t ) . \qquad ( 92 )$$

Hence, considering the field data of FIGS. 4A-4C and 5A-5C as an example, we can easily estimate the disturbance magnitudes to approximately 7.5 kNm and 19 kNm, respectively.

Alternatively, if the dry and sliding friction coefficient of the drill-string-wellbore interface is known, a disturbance magnitude estimate could be computed directly from a torque and drag model of the well.

Tracking

In this Section, we take advantage of the flatness property of the system to solve the trajectory planning problem. Recalling the semi-lumped delay formulation of the model (72)-(75), and writing the flat output z(t)=ω_{L}(t), the flatness of the system allows us to write the other variables as functions of z and its derivatives:

α₀=z(t+D)+ż(t+D)/a_{L} (93)

β₀=z(t−D)−ż(t−D)/a_{L} (94)

α_{L}=z(t)+ż(t)/a_{L} (95)

β_{L}=z(t)−ż(t)/a_{L} (96)

Thus the feed-forward tracking contribution to the top drive set-point becomes

$${ω}_{f} = \frac{z ( t + D ) + z ( t - D )}{2} + \frac{\dot{z} ( t + D ) - \dot{z} ( t - D )}{2 {a}_{L}} , \qquad ( 97 )$$

while the actuation contribution term is

$$\frac{2}{{I}_{T D}} {u}_{f} = {\dot{ω}}_{f} + {a}_{0} {ω}_{f} + \frac{{a}_{0}}{{a}_{L}} \dot{z} ( t - D ) - {a}_{0} z ( t - D ) . \qquad ( 98 )$$

Plugging a reference trajectory z^{ref} (t) into (97), (98) yields the associated feed-forward control law F.

We will use a mollifier (semi-analytical function) to construct transition trajectories that are booth smooth, and have vanishing derivatives at the end and start points. Specifically we use the integral of the “bump” function as a smooth approximation of the step function with vanishing derivatives:

uₘ(t)=∫₀^{t}ϕ(ξ−1)dξ (99)

where the bump function is given as

$$ϕ ( t ) = \{ \begin{matrix}\frac{exp ( - \frac{1}{1 - {t}^{2}} )}{{{\int }^{1}}_{- 1} exp ( - \frac{1}{1 - {ξ}^{2}} ) d ξ} & for t ∈ ( - 1 , 1 ) \\ 0 & otherwise\end{matrix} \qquad ( 100 )$$

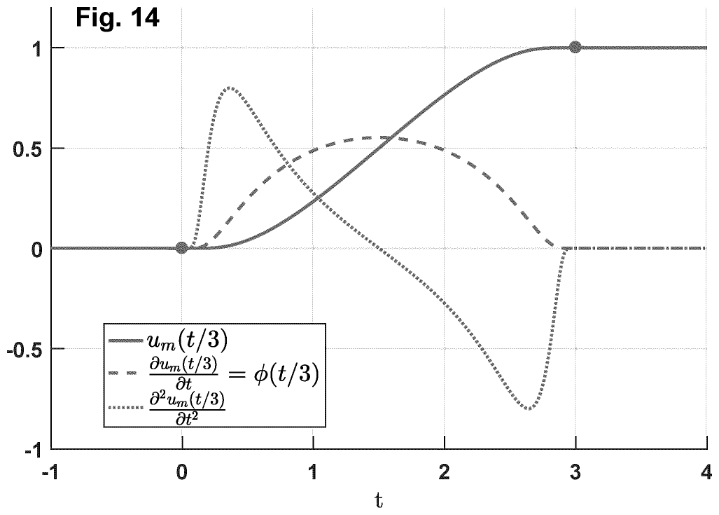

This mollifier step function and its derivatives is illustrated in FIG. 14. It can be used to construct reference trajectories for the downhole RPM, by choosing an amplitude, switching time, and switching duration which we denote as Aₘ, t_{sd}, tₛᵣ, respectively. Hence,

$$z ( t ) = {A}_{m} {u}_{m} ( \frac{t - {t}_{s d}}{{t}_{s r}} ) . \qquad ( 101 )$$

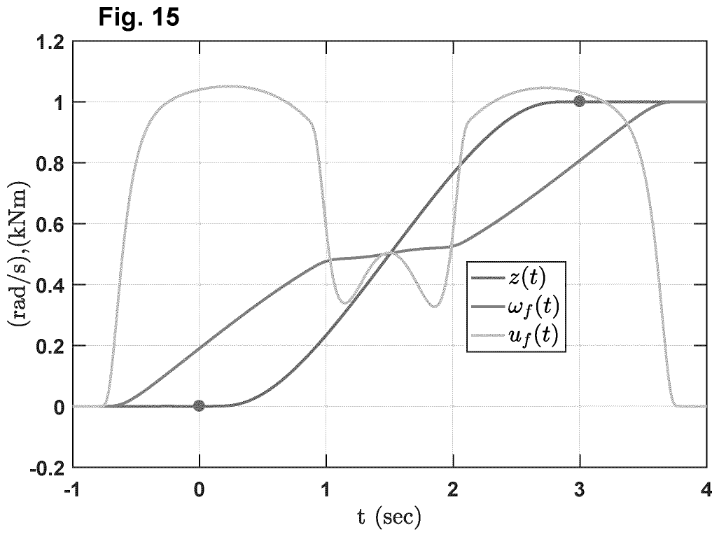

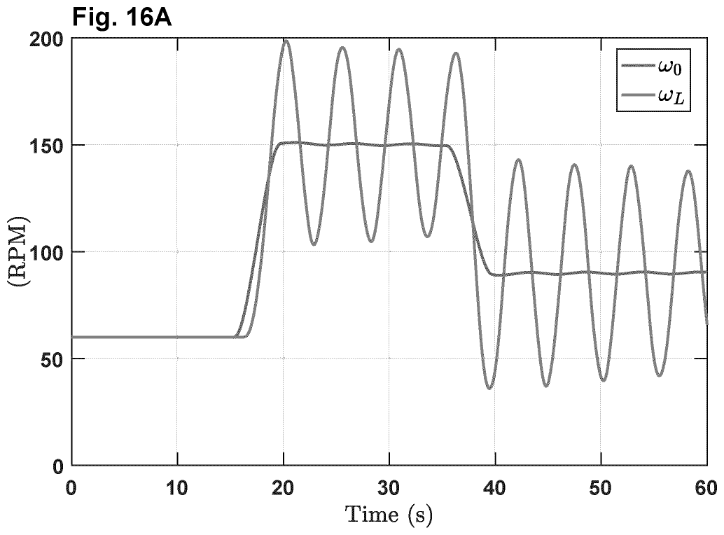

The resulting feed-forward terms are illustrated in FIG. 15.

Simulations

We will argue for the benefit for each of the three components of the control design by considering a series of simulations showing their impact on the dynamics.

Free Drill String

To highlight certain features of the model dynamics, we initially consider the case of a drill string spinning freely with a uniform velocity of 60 RPM and then change the velocity set-point. We will consider the three cases
a) The industry standard high gain PI controller (86).
b) The baseline SoftTorque/torque PI controller (83),(84).
c) The baseline SoftTorque/torque PI controller with the proposed differential flatness trajectory planning feed-forward controller, described elsewhere in the present disclosure.
   For case a) and b), the velocity set-point is changed in two approximate steps according to

$${ω}_{S P} = 60 + 90 {u}_{m} ( \frac{t - 20}{5} ) - 60 {u}_{m} ( \frac{t - 40}{5} ) , \qquad ( 102 )$$

while for case c) Eq. (102) is used as the desired trajectory z^{ref} to generate the set-point and actuation contributions ω_{f} and u_{f} according to (97) and (98).

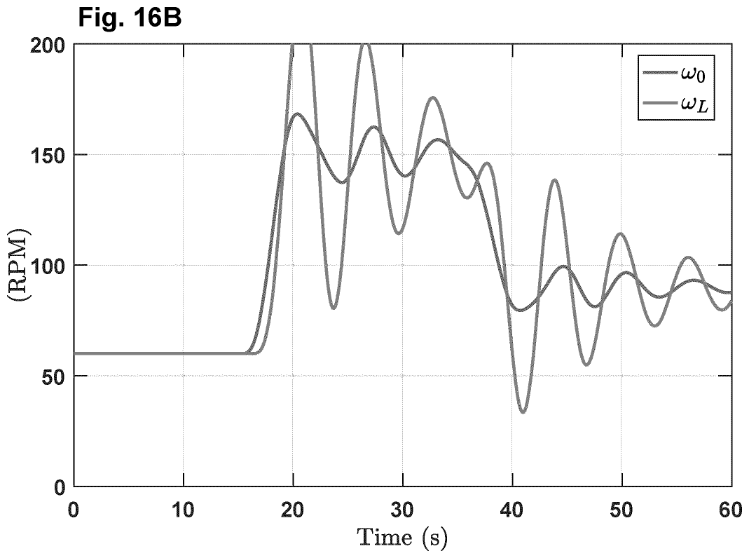

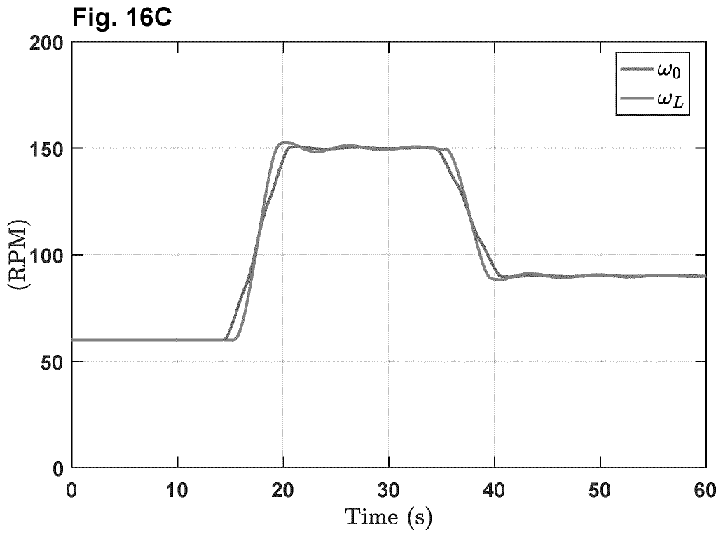

The simulation results are shown in FIGS. 16A-16C. We see that without the trajectory feed-forward controller the set-point changes induces oscillations on the BHA velocity ω_{L}. These oscillations are sustained with the high-gain PI controller, see FIG. 16A, while the SoftTorque/torque controller dampens the oscillations over time, see FIG. 16B. Such oscillations are avoided with the feed-forward flatness controller, see FIG. 16C.

Stick Slip

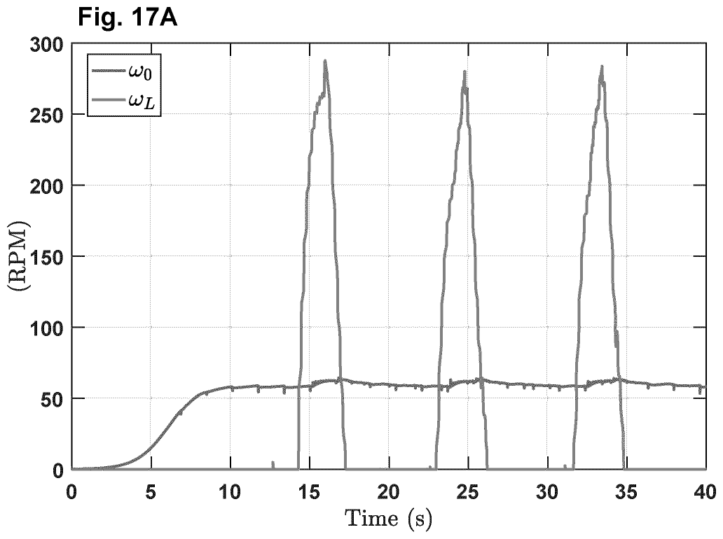

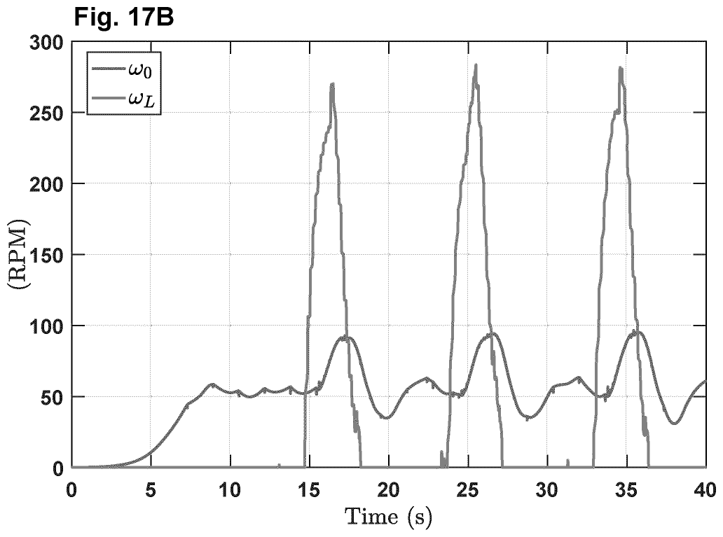

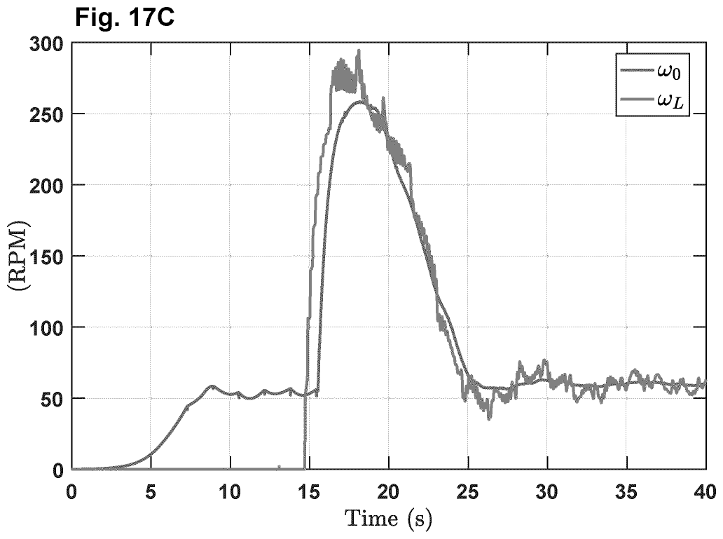

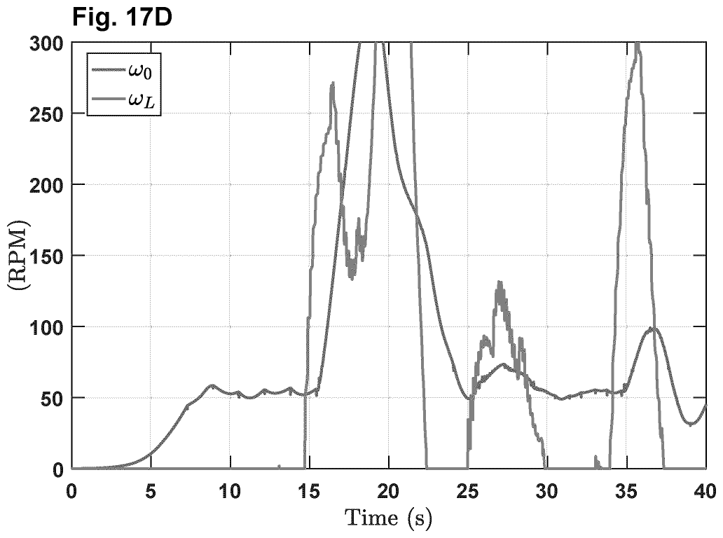

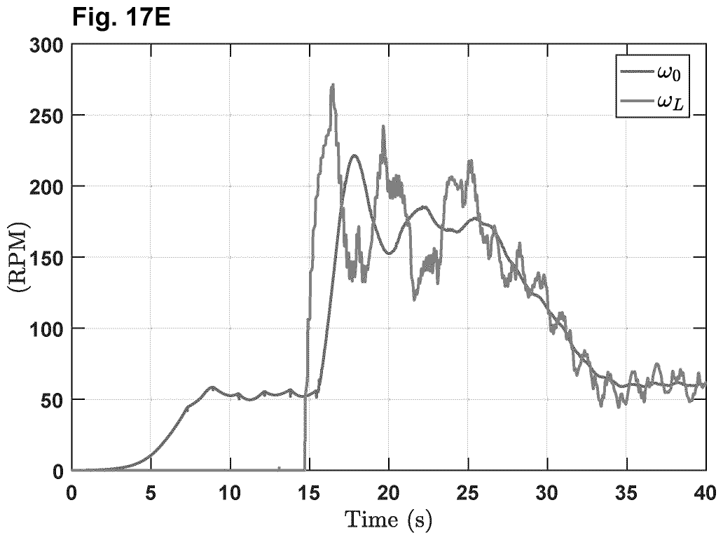

Next we consider a rotation startup such as is required after each pipe connection procedure while drilling a well. In this scenario the stationary drill string is initially kept in place by the Coulomb friction until enough torque is built up to overcome it. At which point, pipe-rotation is initiated and the Coulomb friction is reduced as it changes from static to dynamic. The resulting release of the stored energy potentially pushes the drill string into a destructive stick slip limit cycle. Field data examples of this is shown in FIGS. 4A-4C and 5A-5C. We refer to U. J. F. Aarsnes, R. J. Shor, Torsional vibrations with bit off bottom: modeling, characterization and field data validation, J. Petrol. Sci. Eng. 163 (2018, April) 712-721, for a more detailed description of this phenomena. A replication of this effect, with the industry standard high-gain PI controller (86), is shown in FIG. 17A.

This stick slip limit cycle behavior is considered a significant problem in drilling and was the chief motivation for the development of the SoftSpeed/Torque controllers. Indeed, the SoftSpeed/Torque controllers work for certain cases, and it is not difficult to construct parameter sets where using only this feedback is sufficient for avoiding stick slip. However, the reason this topic is still an area receiving significant ongoing research interest is that the SoftSpeed/Torque controllers are often insufficient to avoid stick slip, which is indeed the case here as well, see FIG. 17B where the baseline SoftTorque/torque PI controller (83), (84), is used.

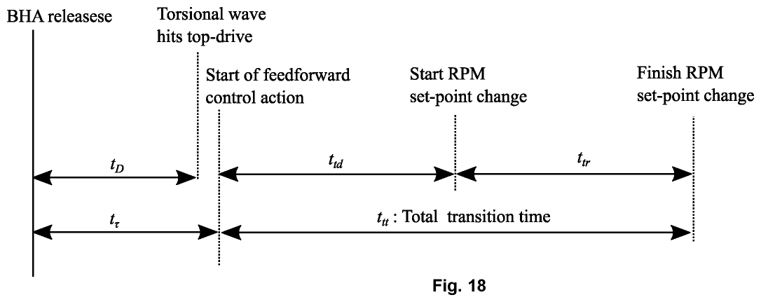

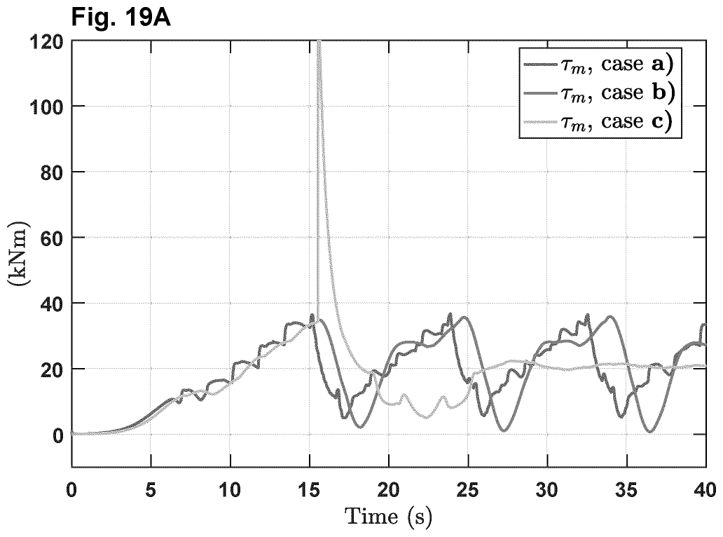

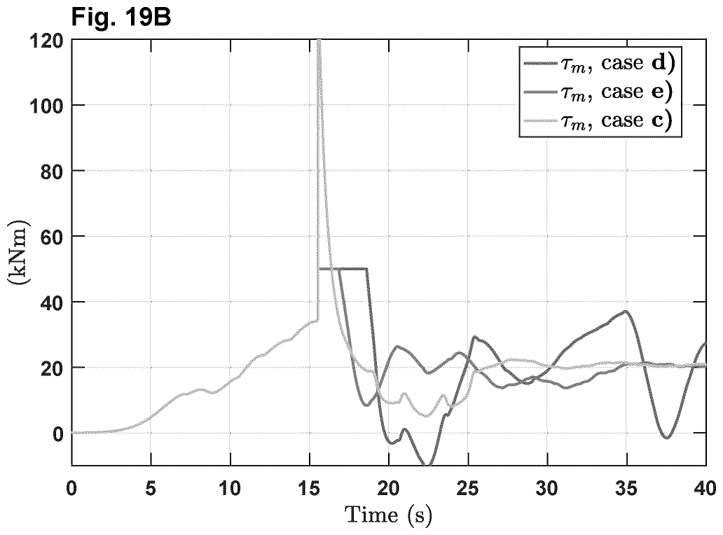

The novel approach proposed in the present paper is to handle the reduction between static and dynamic Coulomb friction as a disturbance that is estimated from previous startups and then canceled with the feed-forward disturbance canceling term derived above. The timing of this approach is summarized in FIG. 18.

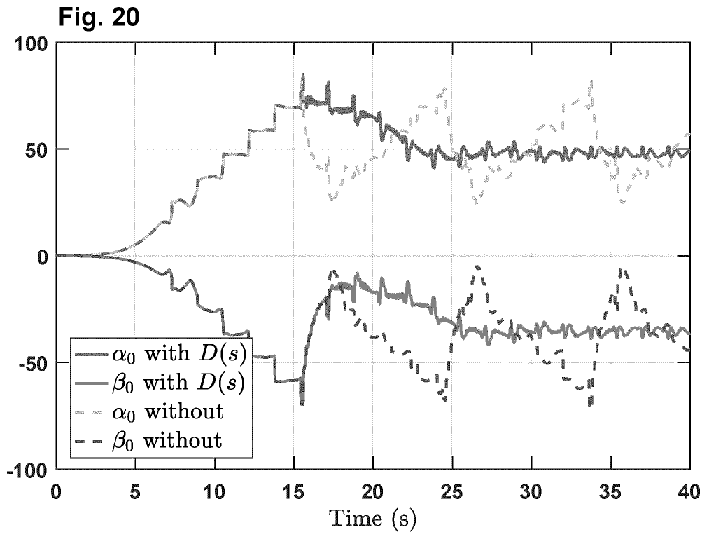

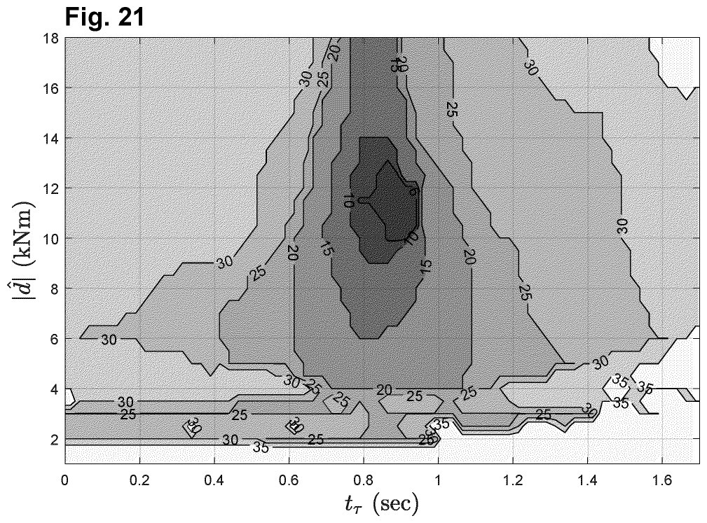

The result of this approach is shown in FIG. 17C, with the torque trend shown in FIGS. 19A and 19B and the topside Riemann invariants shown in FIG. 20. The disturbance cancellation is initiated when an increasing β₀ is estimated, at which point the disturbance feed-forward terms ω_{d}, u_{d} are updated according to (90) and (91). From the torque trend in FIG. 19A we set the estimate \hat{d}=10 kNm. The goal is to cancel the effect in the reflecting α₀, as shown in FIG. 20. This figure shows that the added actuation of the feed-forward term successfully removes most of the reflection compared to the case without using the feed-forward term D. Simultaneous to this, the feed-forward trajectory is updated to bring the drill string velocity back down to the desired 60 RPM without inducing additional oscillations.

Effect of Torque Constraints

In field scenarios, the amount of power available to the rig—due to a constraint in on-site generating capacity—or presence of torque limiters in the top drive controller will set a maximum torque constraint. On typical AC top drives, torque is proportional to electric current, and a large increase in current may cause a power overload. Similarly, a large increase in torque may also exceed the torque limits on gearing or other components in the top drive or near-surface rotary equipment. This constraint on motor torque can limit the effectiveness of the feedforward disturbance canceling part of the controller. This is illustrated in FIG. 17D, where a 50 kNm max torque constraint is used on the actuation. In this case, torsional wave is only partly canceled, an the remaining reflection is sufficient to initiate a stick slip limit cycle. To deal with issues such as this, the robustness of the presented approach can be improved by increasing the time at which the RPM is kept at a high setpoint (angular velocity setpoint) before being lowered to the desired final RPM setpoint. This is illustrated in FIG. 17E where the setpoint is kept at a high RPM for 4 seconds before being lowered to the desired value of 60 RPM. This enables sufficient damping of the reflections and stick slip is avoided. As will be understood by the skilled worker, the angular velocity setpoint can be for any point along the drill string.

Robustness Analysis

Since the approach is based on employing the estimate of the the disturbance, \hat{d}, which is not a-priori known, it is of interest to gage to what degree uncertainty in this estimate can be tolerated. Towards this end, a comprehensive sensitivity study has been carried out where various timings t_{τ} and magnitudes |\hat{d}| of the disturbance estimate was repeatedly used for the same start-up to find the required total transition time t_{τ}+t_{sd}, see FIG. 18, needed to avoid entering a stick slip limit cycle. This study is summarized in FIG. 21, which shows the contours corresponding to the required total transition time for a given magnitude and timing pair |\hat{d}|, t_{τ}.

We see that the least amount of total transition time is required around the |\hat{d}|=12 kNm, t_{τ}=t_{D}=0.81, which corresponds to the magnitude and timing that was computed a priori. Further, we note that a great deal of uncertainty is allowed by the approach when the transition time is allowed to be sufficiently large, in this case tₜₜ≈0 30-35 seconds of total transition time enables us to avoid stick slip even for a very-wide range of disturbance estimates.

We conclude from the robustness analysis that there is a trade-off between performance, parametrized in total transition-time tₜₜ, and robustness, parametrized in allowable uncertainty in \hat{d}. And, that if a sufficient lenient total transition-time tₜₜ is chosen, the proposed approach is robust to the aforementioned uncertainties.

Error of Lumped Approximation

We will derive the input-output description of the drill string between the input ω₀ and the output τ₀, without the top-drive (as it acts as a lowpass filter masking the approximation error). Denote this transfer function

$$\frac{{T}_{0}}{{Ω}_{0}} ( s ) ≡ {g}_{0} ( s ) . \qquad ( 103 )$$

For a two-section drill string, ignoring the non-linear part of the source term, it can be found that:

$$\begin{matrix}{g}_{c} ( s ) = {Z}_{c} \frac{{Z}_{L} + {Z}_{C} tan h {Γ}_{c}}{{Z}_{c} + {Z}_{L} tan h {Γ}_{c}} & ( 104 ) \\ {g}_{0} ( s ) = {Z}_{p} \frac{{g}_{c} + {Z}_{p} tan h {Γ}_{p}}{{Z}_{p} + {g}_{c} tan h {Γ}_{p}} . \\ with & ( 105 ) \\ {Z}_{p} \text{:} = \frac{{J}_{p} {G}_{p}}{{c}_{t}} \sqrt{1 + \frac{k}{s}} , {Γ}_{p} \text{:} = s \frac{{L}_{p}}{{c}_{t}} \sqrt{1 + \frac{k}{s}} , & ( 106 ) \\ {Z}_{c} \text{:} = \frac{{J}_{c} {G}_{c}}{{c}_{t}} \sqrt{1 + \frac{k}{s}} , {Γ}_{c} \text{:} = s \frac{{L}_{c}}{{c}_{t}} \sqrt{1 + \frac{k}{s}} , & ( 107 )\end{matrix}$$

and with the load impedance Z_{L}=0 for the case of bit off bottom.

Now consider the following approximation of the two-section drill string, where the collar section has been lumped into a single inertia element:

$$\begin{matrix}{\tilde{g}}_{0} ( s ) = {Z}_{p} \frac{{Z}_{B H A} + {Z}_{p} tan h {Γ}_{p}}{{Z}_{p} + {Z}_{B H A} tan h {Γ}_{p}} , & ( 108 ) \\ {Z}_{B H A} = {J}_{C} {L}_{C} ρ s ( 1 + k / s ) ≡ {I}_{B H A} ( s + 1 / k ) . & ( 109 )\end{matrix}$$

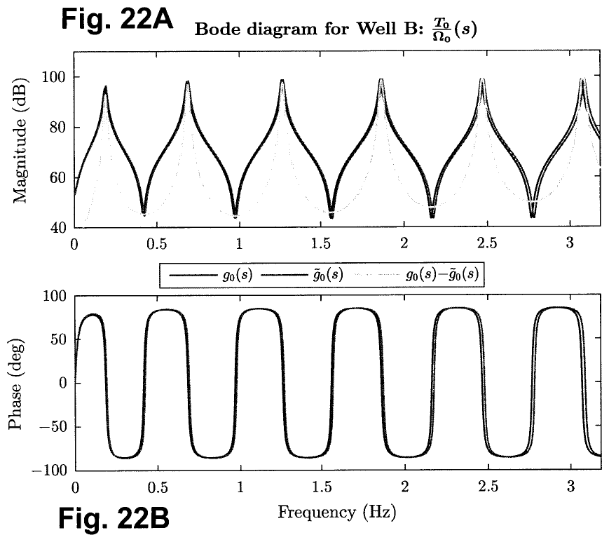

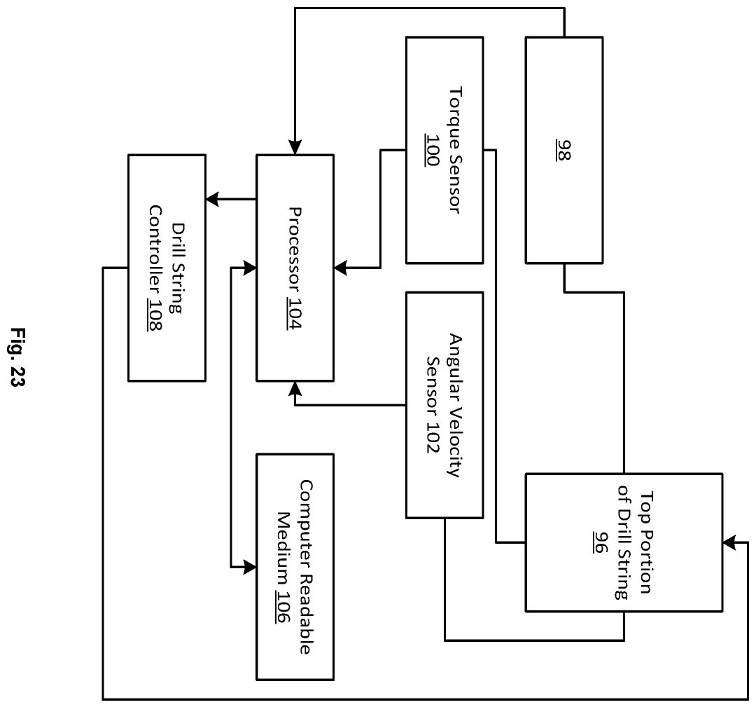

This approximation is shown in FIGS. 22A and 22B.

The fit is good for lower frequencies, but becomes gradually worse for very high frequencies, which is what we would expect from a lumped approximation.

FIG. 23 shows an embodiment of a system in accordance with the present disclosure. The system has sensors coupled to the top portion of the drill string 96. The sensor measure values of variables of the top portion of the drill string 96. The sensors include torque sensor 100 for measure the torque applied at the top portion of the drill string 96 and an angular velocity sensor 102 to measure the angular velocity of the top portion of the drill string 96. Other sensors, such as sensor 98, can be coupled to the top portion of the drill string 96 to measure any other suitable variable of the drill string 96.

The system of FIG. 23 further has processor 104 that is coupled to the sensors 98, 100 and 102. The processor 104 is also coupled to a non-transitory, tangible computer readable medium 106 that has instructions recorded thereon. The instructions are to be carried out by the processor 104 to obtain a soft sensor to generate estimated values of variables of the BHA in accordance with the top portion measured values and in accordance with angular motion equations of the drill string. The soft sensor can be as described in the embodiments of the present disclosure. In some embodiments, the angular motion of the equations are those described above.

The system of FIG. 23 further has a drill string controller 108 coupled to the processor 104 and configured to generate a control signal in accordance with the estimated values of variables of the BHA. The control signal of the drill string controller 108 controls the top portion of the drill string 96. As will be understood by the skilled worker, the control signal can cause the angular velocity of the top portion of the drill string 96 to increase, to decrease, or to remain at its present value. Further, the control signal can cause the torque applied to the top portion of the drill string 96 to increase, to decrease, or to remain at its present value.

The control signal can be any suitable type of electrical signal. The drill string controller 108 can include any suitable type of circuitry configured to receive sensor signals from the sensors 98, 100 and 102 and any suitable type of circuitry to generate the control signal to control the top portion of the drill string 96. As will be understood by the skilled worker and even though not shown, one or more than one motor configured to rotate the drill string is operationally connected to the top of the drill string and the control signal can control the one or more than one motor, and; there can be additional sensors connected to the drill string, at any portion of the drill string, to measure drill string variables along the length of the drill string. In some embodiments, the control signal can include an optical control signal and the drill string controller can include circuitry to generate the optical control signal. In such embodiments, the top portion of the drill string can be configured to receive the optical control signal and to convert the optical control signal into an electrical signal to control one or more than one motor configured to rotate the top portion of the drill string. As will also be understood by the skilled worker, the present disclosure does not exclude the presence or use of any suitable, known drilling equipment in the practice of the present disclosure.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art. The scope of the claims should not be limited by the particular embodiments set forth herein, but should be construed in a manner consistent with the specification as a whole.

1. A system for controlling a drill string located in a borehole, the drill string having a top portion and a bottom hole assembly (BHA) coupled to the top portion, the system comprising:
a processor;
sensors coupled to the top portion of the drill string, the sensors being further coupled to the processor, the sensors configured to measure values of variables of the top portion of the drill string, to obtain top portion measured values;
a non-transitory, tangible computer readable medium having instructions recorded thereon, the instructions to be carried out by the processor to obtain a soft sensor to generate estimated values of variables of the BHA in accordance with the top portion measured values and in accordance with angular motion equations of the drill string; and
a drill string controller configured to generate a control signal in accordance with the estimated values of variables of the BHA, the drill string controller to control the top portion in accordance with the control signal.

2. The system of claim 1, wherein the sensors include a torque sensor measuring a torque applied to the top portion and an angular rotation sensor to measure an angular velocity of the top portion of the drill string.

3. The system of claim 2, wherein the angular motion equations include:
$$\frac{\partial τ ( t , x )}{\partial t} + J G \frac{\partial ω ( t , x )}{\partial x} = 0 , \\ and$$
$$J ρ \frac{\partial ω ( t , x )}{\partial t} + \frac{\partial τ ( t , x )}{\partial x} = S ( t , x )$$
the angular velocity of the of the drill string being denoted by ω(t,x), the torque on the drill string being denoted τ(t,x), a density of the drill string being denoted by ρ, time being denoted by t, a position along the drill string being denoted by x, J being a polar moment of inertia of the drill string and G being a shear modulus of the drill string,
S(t,x)=−kₜρJω(t,x)− [symbol] (ω,τ,x),
S(t,x) being a source term accounting for frictional contact of the drill string with the borehole, where kₜ is a constant damping term representing viscous shear stresses between the drill string and drilling mud, and [symbol] (ω,τ,x) being a differential inclusion representing Coulomb friction between the drill string and the borehole.

4. The system of claim 3, wherein the differential inclusion is defined as:
$$\{ \begin{matrix}ℱ ( ω , x ) = {μ}_{k} {F}_{N} ( x ) , ω > {ω}_{c} , \\ ℱ ( ω , x ) ∈ [ - {μ}_{s} {F}_{N} ( x ) , {μ}_{s} {F}_{N} ( x ) ] , \vert ω \vert < - {ω}_{c} , \\ ℱ ( ω , x ) = - {μ}_{k} {F}_{N} ( x ) , ω < - {ω}_{c} ,\end{matrix}$$
where F_{N} is the normal force acting between the drill string and a wall of the borehole, ω_{c} is a threshold on the angular velocity where the Coulomb friction switches from static to kinetic, μₛ, μₖ are the static and kinetic friction factors, respectively, and
$$ℱ ( ω , τ , x ) = - \frac{\partial τ ( t , x )}{\partial x} - {k}_{t} ρ J ω ( t , x ) ∈ [ - {μ}_{S} {F}_{N} ( x ) , {μ}_{S} {F}_{N} ( x ) ]$$

5. The system of claim 1, wherein the drill string controller is further configured to generate the control signal in accordance with a set point of the angular velocity of the top portion of the drill string.

6. The system of claim 1, wherein the drill string controller is further configured to generate the control signal in accordance with a set point of the angular velocity of any point along the drill string.
